(19) United States
(12) Patent Application Publication
(10) Pub. No.: US 2014/0128166 A1
(43) Pub. Date: May 8, 2014

(54) GAME ENHANCEMENT SYSTEM FOR GAMING ENVIRONMENT

(71) Applicants: Wesley Tam, Ottawa (CA); Eric Dalrymple, Ottawa (CA); Deborah Pinard, Dunrobin (CA)

(72) Inventors: Wesley Tam, Ottawa (CA); Eric Dalrymple, Ottawa (CA); Deborah Pinard, Dunrobin (CA)

(73) Assignee: GLITCHSOFT CORPORATION, Kanata (CA)

(21) Appl. No.: 14/154,237

(22) Filed: Jan. 14, 2014

Related U.S. Application Data
(63) Continuation of application No. PCT/CA2011/000844, filed on Jul. 22, 2011.

(51) Int. Cl. A63F 13/30

(52) U.S. Cl. CPC A63F 13/12
USPC 463/42

(57) ABSTRACT

A data analytics system for a video game where a player interacts with the video game through an avatar representing his own persona within a virtual environment. A data gathering module associated with the game for gathers data about the behavior of the avatar under the control of the player in response to virtual situations presented to the player within the game. An analytics module for analyzes the data collected by the data gathering module data to identify a player profile based on the gathered data relating to the behavior of the avatar under the control of the player. A game modifying module modifies the virtual environment based on the identified profile of the player or a group of players.

### CROSS-REFERENCE TO RELATED APPLICATIONS

This patent application claims the benefit of International Application WO/2013/013281 published under the Patent Cooperation Treaty, being PCT/CA2011/000844 filed Jul. 22, 2011 entitled “Game Enhancement System for Gaming Environment”, the entire contents of this patent application being included by reference.

### FIELD OF THE INVENTION

This invention relates to the field of gaming, and more particularly to enhancement of the gaming experience within the context of video gaming environments.

### BACKGROUND OF THE INVENTION

The telecommunications market is in a transition period where feature phones are being replaced by Smartphones. The smartphone is no longer seen as a device for solely business purposes and the commercial entertainment value of a Smartphone is due entirely to the advent of mobile gaming. With a more sophisticated phone comes the desire for a more sophisticated game.

The introduction of 3G and 4G mobile network technologies have made possible the access of the browser-based web services such as Web, WAP, and i-Mode on mobile phones, PDAs, and other portable gadgets. The growth of mobile Internet uptake continues apace with the proliferation of flat-rate data tariffs and an explosion of mobile internet centric devices following the arrival of the iPhone 3G and Google's Gl Android phone. This has raised prospects to boost offering of digital mapping and navigational content, applications and services on mobile phones. This is expected to generate added business opportunities within the location based services (LBS), mobile search and mobile advertising markets, to diversify multimedia content market, and to support development of third-party applications and platforms.

Social media is becoming a fully integrated part of modern life and in tandem with this is the relatively new phenomenon of social gaming. One of Smartphone's strengths lies in the ease of access they provide to social media content. Most top social media sites have a number of separate clients that allow Smartphone users to access the service on the go. Social media is based on connectivity and social media gaming is an extension of that connectivity. A Smartphone already combines all of these features. Social Media Gaming thrives on a network of players able to connect, collaborate and communicate with each other to help out in the game-play.

Digital distribution, digital delivery or electronic software distribution is the practice of delivering content without the use of physical media, typically by downloading via the internet. Digital distribution bypasses conventional physical distribution media, such as paper or DVDs. Digitally distributed content may be streamed or downloaded. Streaming involves downloading and using content “on-demand” as it is needed. Meanwhile, fully downloading the content to a hard drive or other form of storage media allows for quick access in the future. Because of digital distribution, many opportunities to improve games arise, since new content can be pushed in real time, or a game can be updated on the fly.

The current state of dynamic story telling in games is limited by traditional means of video game distribution. Leaders of the dynamic story telling video game genre design their products with the traditional forms of distribution in mind. Even though they distribute some of their content digitally post launch, the content provided is not truly dynamic. There are two main paradigms that are currently used. First, a static based approach where content authors and designers design multiple scenarios that push the player down specific story/content branches based on the actions and decisions the player made in the game. The second uses algorithms/simulation to model non playable characters and environment. These entities attempt to react and adapt to the players inputs.

In both cases, the content is limited to what is already baked into the product, or what the algorithm is capable of doing. Like a “choose your own adventure” book, these branches are pre-baked by designers and determined by dynamic content algorithms and behaviours. The player is not presented a story, characters and environments that adapt to their actions. Algorithms and simulations only give a specific range of dynamic reaction to the player; they are artificial and can feel generic. Both solutions do not provide enough fidelity to present a truly dynamic story.

In some video games, avatars change towards good or evil based on player behavior, or paths can be chosen based on good and evil. However, there are only 2 paths that can be followed in these games, good or evil.

The industry has begun to deliver content digitally in episodic form. Each episode is crafted using traditional production processes. With the rise of network connectivity and analytics, players' responses, behaviours, decisions and outcomes can all be recorded as a means to drive the direction of new episodic content.

The existing state of dynamic story telling in games is ongoing downloadable content. The majority of games tend to drive the player forward; the plot is such that once the player has finished a chapter they move on to the next area and can't come back. In newer games, some characters and situations react differently to males and females, and some situations develop differently for characters with different classes and backgrounds, but many do not. The seams where specific interactions are inserted or modified are sometimes apparent. The primary plot is constrained, but there are some subtle variations in its development, and many subplots and side stories can be opened up. The main story arc is developed, but there are also many incidental paths that can be discovered and pursued (or ignored) along the way. These sub-stories provide a broader variety of player experience than most games aspire to, and players who hope to earn all of the achievements and see all of the content will spend time exploring these incidental storylines. When the player has finished the central story, the game ends.

Another trend in games is when the game foregoes all the figurative images and rules which are in many of the current games; there are no puzzles, no pre-set action moments for the player to wander into, no forced redirections around contrived path blockades. The player's avatar has no back-story or personality. Apart from a handful of story cues, many of which vary depending on choices made over the course of the adventure, the player is left to create their own drama and to form their own character. Everything in the game revolves and grows around the player. The character is built by the manner the player chooses to move through the game, with the Role Playing Game (RPG) elements allowing almost complete personalization of the character. Dialogue trees give room to develop some semblance of a personality. Delays and distractions like puzzles are discarded in a favor of a series of problems, most of which are consequences of behavior earlier in the game and go on to form new challenges when overcome. Games claiming to give players freedom usually allow players to explore in between story sections which have every step of progression strictly regimented. Although loosely linear in narrative structure (the story will travel to certain points in a defined order no matter what the player does), this type of game gives players control and influence over the smaller threads of the story. Actions in the game have consequences, and part of the games' entertainment is not only the thrill of finding out what consequences actions will yield, but also the fear that that the player has taken a wrong turn or made a bad choice. Preventing the continuity of the game from being broken is the presence of one influential central character. An overdeveloped story in a game can deride from the player's experience by taking away the thrill of discovery and exploration that only an interactive medium can offer. The story is demoted to the role of background guide, ensuring the player never feels lost or lacking important goals. Exploratory games feel less like walking through a plot and more like exploring a vision.

Another new part to games is a morality scoring system, based on the player's actions and dialogue choices. If the player chooses to be a hero who always does the right thing, a related set of points are scored. The player can also choose to take on illegal tasks, or cause casualties, earning a different type of points. Some choices are hard to avoid, and players who are trying to do the right thing can still get both types of points. These types of decisions are not only limited to good or evil, political and personal beliefs can also be expressed in dialogue choices, even when the net effect will be the same within the story. This approach gives the player ownership of the character, and one garners' experience is likely to be different from another's. There are subplots based on conversation and affinity, and the player's own preferences influence relationships. Decisions made in the first chapter of a game may change what happens in the next or subsequent phases of the story.

Games also allow users to create user generated content or items that a gamer can download and add to their existing game.

Targeted user information continues to emerge about who plays games, spurring interest on the part of advertising agencies as to how games can be used to reach specific markets.

Advertising is a crucial means for brands to promote their products and services. Many advertisers believe gaming can provide the distinctive edge that their ad campaign needs. Traditional advertising methods such as print, TV and radio are becoming less popular with brands and advertisers as they are unable to reach consumers as effectively as they would wish, and they do not provide immediate performance feedback. Early examples of in-game advertising were static. Some of these examples consisted of virtual billboards, whereas others could be considered in-game product placement. These advertisements were placed directly into games by artists or programmers and could not be changed at any time.

Increasing Internet connectivity has led to the growth of dynamic in-game advertising.

Unlike fixed advertisements found in static in-game ads, dynamic advertisements can be altered remotely by the advertising agency. Advertisements can be tailored according to numerous filters including geographical location, time of day, etc. and allow for the delivery of time-critical advertising campaigns, such as those publicizing an upcoming movie launch. Information can be sent back from the player's machine regarding advertisement performance; data such as time spent looking at advertisements, type of advertisement and viewing angle may be used to better formulate future campaigns and also allows the advertising agency to offer more flexible advertising campaigns to their clients. In the dynamic advertising model, for example, the ad on the billboard in the driving game will change each time you go around the block. The model is most effective when large numbers are playing online. The software is designed to put a blank box in the game. That blank box reaches out to the Internet and pulls information in real time and fills the box with an ad, which is updated on the server. A company called Massive has what they call the Massive Network which offers advertisers the ability to reach and engage the video game audience across leading game titles in the most significant game genres. Advertisers have complete control over the content included in their media buy and the timing of their campaigns.

Distribution is the key for any ad-funded game. No matter how good the game is, if players don't play then the advert element will be lost. Therefore key tie-ups with social networkers, capturing audience interest as well as harnessing user opt-in so that loyalty can be built up is essential. Registration within the game can allow brands increased access to users, as well as on-going relationship building, plus allowing for the increased up-sell of pay-to-play. Games will however be limited by the inventiveness, creativity and user-friendly nature of the developers, directed by the brand-marketers and harnessing the technology provided by improved networks and handsets. Advertising in gaming has normally been placed under different categories as follows: ATL (Above the Line): games are provided on a website hoping to draw potential customers to the game or spend more time on a site; BTL (Below the Line): games are usually focused on commercial, political or educational subjects.

Advertising within a game itself such as on billboards is also classed as BTL advertising in gaming; TTL (Through the Line): are rarely used in advertising in gaming in comparison to other methods. URL hyperlinks are used within games in order to entice users to visit a site containing BTL advertisements; and Product placement: is a method used to integrate advertised products, services and brands into the game play. Virtual worlds (such as Second Life) and universal business simulations are best suited to this type of advertising in gaming technique.

The fastest growing content categories via mobile Internet application are social networking, news, sports information, weather, movie information, and retail.

An avatar is a user's representation of himself/herself or alter ego. Traditionally the avatar that a gamer uses is created at startup, and is static once created. The user can change basic characteristics, like clothing, hair colour and style, etc. Some games have an extensive set of emotes, moods, and associated animations, which affect not only an avatar's physical appearance but also the text used to describe a character's speech, and even the shape of the speech bubble displayed on-screen. Games are starting to expose an Avatar API so that avatars can be changed by an external source. Microsoft's XNA framework 3.1 has an API to support Avatars in Indie Games. Kongregate's Avatar Export API gives you the ability to export in-game avatars and let users use them as their Kongregate profile avatar. Avatar creation tool Meez has an API platform, in-game avatars, (“Meez Inside”) makes it so that users can import their avatars into a game and use it to represent them as they play. As games become more sophisticated, having API's to control inputs to the game will become more common.

The rapid evolution and commoditization of communication services technologies has paved the way for the development of identifying people, objects and data by their geographical location as a business opportunity. One way to identify the data and objects by their physical location is by geotagging them—the process of adding geographical identification metadata to various media such as photographs, video, websites, RDF or RSS feeds and is a form of geospatial metadata. GPS is increasingly becoming the technology of choice for mobile Location Based Services (LBS). The growth of GPS in mobile is key to the future of geotagging. The spread of GPS, coupled with the huge improvements in the quality of cameras on handsets, mean that many users have now bought into device convergence—their phone is also their digital camera, and their MP3 player, and much more besides. Mobile mapping and geotagging has great potential due to the relationship between a mobile subscriber and their handset, where the mobile device is often with the end-user for most of their waking time.

With mobile penetration reaching 100% in many developed markets, the mobile camera phone will soon be in virtually everyone's pocket. Social networking and user generated content forms another market upon which geotagging is dependent. The importance of online and mobile communities has grown rapidly throughout the world—social networking is the now 4th largest sector on the Internet. Alongside other types of multimedia content, millions of images are uploaded onto these sites by their users' every day, creating opportunities for the development of a whole range of applications by third-party vendors. Already, there are many applications for geotagging the content by location on general social media sites i.e. Facebook and MySpace and photo-centric sites like Flicker. Augmented Reality (AR) is a term used to describe a view of a real-world environment that has an over layering of virtual, computer-generated content. This content serves to augment the original view by adding a variety of extra visual or audible capabilities, through a superimposed 3D Graphical User Interface (GUI).

Some applications use image recognition, where input to the camera is compared against a library of images to find a match. Applications are emerging that can detect and interpret gestures and postures as commands to perform certain functions.

Media Augmented Reality (MAR) is when a view of reality is modified by a computer and as a result the technology functions by enhancing a user's current perception of reality. It has generated the first category of applications on smartphones that have utilized the data combination from camera, GPS, digital compass, accelerometers and broadband connection to interact with the user's immediate physical surroundings in such a way. This technology is available today.

In 1978, Greg Stafford developed a role playing board game that used 13 personality trait dichotomies to represent ethical values in a character. These were: Chaste vs. Lustful, Energetic vs. Lazy, Forgiving vs. Vengeful, Generous vs. Selfish, Honest vs. Deceitful, Just vs. Arbitrary, Merciful vs. Cruel, Modest vs. Proud, Pious vs. Worldly, Prudent vs. Reckless, Temperate vs. Indulgent, Trusting vs. Suspicious, Valorous vs. Cowardly. The traits were made to represent the genre of Arthurian romantic fantasy. The actions of the players influenced the character personality. In contemporary psychology, the “Big Five” factors (or Five Factor Model; FFM) of personality are five broad domains or dimensions of personality which are used to describe human personality. The Big Five factors and their constituent traits can be summarized as:

Openness—(inventive/curious vs. consistent/cautious). Appreciation for art, emotion, adventure, unusual ideas, curiosity, and variety of experience.

Conscientiousness—(efficient/organized vs. easy-going/careless). A tendency to show self-discipline, act dutifully, and aim for achievement; planned rather than spontaneous behaviour.

Extraversion—(outgoing/energetic vs. solitary/reserved). Energy, positive emotions, surgency, and the tendency to seek stimulation in the company of others.

Agreeableness—(friendly/compassionate vs. cold/unkind) A tendency to be compassionate and cooperative rather than suspicious and antagonistic towards others.

Neuroticism—(sensitive/nervous vs. secure/confident). A tendency to experience unpleasant emotions easily, such as anger, anxiety, depression, or vulnerability.

The Big Five model is a comprehensive, empirical, data-driven research finding. Identifying the traits and structure of human personality has been one of the most fundamental goals in all of psychology. The five broad factors were discovered and defined by several independent sets of researchers (Digman, 1990). These researchers began by studying known personality traits and then factor-analyzing hundreds of measures of these traits (in self-report and questionnaire data, peer ratings, and objective measures from experimental settings) in order to find the underlying factors of personality.

Openness—(inventive/curious vs. consistent/cautious) is a general appreciation for art, emotion, adventure, unusual ideas, imagination, curiosity, and variety of experience. The trait distinguishes imaginative people from down-to-earth, conventional people. People who are open to experience are intellectually curious, appreciative of art, and sensitive to beauty. They tend to be, compared to closed people, more creative and more aware of their feelings. They are more likely to hold unconventional beliefs.

People with low scores on openness tend to have more conventional, traditional interests. They prefer the plain, straightforward, and obvious over the complex, ambiguous, and subtle. They may regard the arts and sciences with suspicion or even view these endeavors as uninteresting.

Conscientiousness—(efficient/organized vs. easy-going/careless) is a tendency to show self-discipline, act dutifully, and aim for achievement against measures or outside expectations. The trait shows a preference for planned rather than spontaneous behavior. It influences the way in which we control, regulate, and direct our impulses.

Extraversion—(outgoing/energetic vs. solitary/reserved) is characterized by positive emotions, surgency, and the tendency to seek out stimulation and the company of others. The trait is marked by pronounced engagement with the external world. Extraverts enjoy being with people, and are often perceived as full of energy. They tend to be enthusiastic, action-oriented individuals who are likely to say “Yes!” or “Let's go!” to opportunities for excitement. In groups they like to talk, assert themselves, and draw attention to themselves. Introverts lack the social exuberance and activity levels of extraverts. They tend to seem quiet, low-key, deliberate, and less involved in the social world. Their lack of social involvement should not be interpreted as shyness or depression. Introverts simply need less stimulation than extraverts and more time alone. They may be very active and energetic, simply not socially.

Agreeableness—(friendly/compassionate vs. cold/unkind) is a tendency to be compassionate and cooperative rather than suspicious and antagonistic towards others. The trait reflects individual differences in general concern for social harmony. Agreeable individuals' value getting along with others. They are generally considerate, friendly, generous, helpful, and willing to compromise their interests with others. Agreeable people also have an optimistic view of human nature. They believe people are basically honest, decent, and trustworthy.

Disagreeable individuals place self-interest above getting along with others. They are generally unconcerned with others' well-being, and are less likely to extend themselves for other people. Sometimes their skepticism about others' motives causes them to be suspicious, unfriendly, and uncooperative.

Neuroticism—(sensitive/nervous vs. secure/confident) is the tendency to experience negative emotions, such as anger, anxiety, or depression. It is sometimes called emotional instability. Those who score high in neuroticism are emotionally reactive and vulnerable to stress. They are more likely to interpret ordinary situations as threatening, and minor frustrations as hopelessly difficult. Their negative emotional reactions tend to persist for unusually long periods of time, which means they are often in a bad mood. These problems in emotional regulation can diminish the ability of a person scoring high on neuroticism to think clearly, make decisions, and cope effectively with stress.

At the other end of the scale, individuals who score low in neuroticism are less easily upset and are less emotionally reactive. They tend to be calm, emotionally stable, and free from persistent negative feelings. Freedom from negative feelings does not mean that low scorers experience a lot of positive feelings.

These five factors can be further understood by looking at the following two tables of single pole markers for each trait. The table of trait markers lists the top 10 adjectives that correlate most positively with each factor. The table of inverse trait markers lists the top 10 adjectives that correlate most negatively with each factor.

Trait Markers:

| | Agree- | Conscien- | Emotional | |
|---|---|---|---|---|
| Surgency | ableness | tiousness | Stability | Intellect |
| Extraverted | Kind | Organized | Unenvious | Intellectual |
| Talkative | Cooperative | Systematic | Unemotional | Creative |
| Assertive | Sympathetic | Thorough | Relaxed | Complex |
| Verbal | Warm | Practical | Imperturb- | Imaginative |
| | | | able | |
| Energetic | Trustful | Neat | Unexcitable | Bright |
| Bold | Conscien- | Efficient | Undemanding | Philosophical |
| | tious | | | |
| Active | Pleasant | Careful | | Artistic |
| Daring | Agreeable | Steady | | Deep |
| Vigorous | Helpful | Conscien- | | Innovative |
| | | tious | | |
| Unrestrained | Generous | Prompt | | Introspective |

Inverse Trait Markers:

| | Agree- | Conscien- | Emotional | |
|---|---|---|---|---|
| Surgency | ableness | tiousness | Stability | Intellect |
| Introverted | Cold | Disorganized | Emotional | Unintellectual |
| Shy | Unkind | Careless | Irritable | Unintelligent |
| Quiet | Un- | Un- | Fretful | Unimaginative |
| | sympathetic | sympathetic | | |
| Reserved | Distrustful | Inefficient | Jealous | Uncreative |
| Untalkative | Harsh | Undependable | Touchy | Simple |
| Inhibited | Demanding | Impractical | Nervous | Un- |
| | | | | sophisticated |
| Withdrawn | Rude | Negligent | Insecure | Unreflective |
| Timid | Selfish | Inconsistent | Fearful | Imperceptive |
| Bashful | Un- | Haphazard | Self- | Uninquisitive |
| | cooperative | | pitying | |
| Un- | Uncharitable | Sloppy | High- | Shallow |
| adventurous | | | strung | |

Cattell (1905-present) viewed language is a useful source of information about personality. A quality described by many words, he figured, was likely to be a more important part of personality. Cattell used this lexical criterion in determining his original list of trait names. Cattell narrowed Allport and Odberts (1936) listing of 17,000+ words down to 4,500 words and then narrowed these down further to 171 trait names. Cattell then collected self-ratings on these words and then conducted factor analysis. He used both observer and behavioural data. The result was his sixteen personality factors: reserved v warm; concrete reasoning v abstract reasoning; reactive v emotionally stable; deferential v dominant; serious v lively; expedient v rule-conscious; shy v socially bold; utilitarian v sensitive; trusting v vigilant; practical v imaginative; forthright v private; self-assured v apprehensive; traditional v open-to-change; group-oriented v self-reliant; tolerates disorder v perfectionist; relaxed v tense.

A new trend that has been emerging in the video game industry quite recently is metrics-driven design. In this approach, the game developer laces the product (or game) with code that reports usage statistics and player behaviour back to the developer via an online network. The developer then releases the product at its minimal viable state; a state in which the product is not necessarily complete with regards to its full scope, but is complete enough to appear complete to, and to be enjoyed by end users purchasing the product. From this point on, the developer accumulates reported usage metrics and uses these metrics to flesh out the rest of the product before releasing another iteration of it in an update. In other words, they design most of the product in a way that they think will attract the most consumers according to the data they get back from the “unfinished” version of the product. This approach is not always used within the scope of one project, but can be used to shape a later project, such as a sequel. The developers in question not only use this data to drive game design, but can also use it to drive in-game content and advertising.

Various problems are associated with existing technology and include the fact that: Advertisers can't get immediate feedback on ads, or what consumers would choose in certain situations; Specific companies will custom-develop complex games for large brand marketers allowing further game-play with additional features (These are expensive and can get outdated quickly); Advertisers partner with developers to have products embedded in games, often pay-to-play high-end games, suited to higher end handsets (They are also static—every player sees the same advertisement, and they are fixed for a particular version of the game. These are expensive and can get out-dated quickly); People who game don't always have the time to catch up on what is going on in the real world—they are immersed in the game and spend most of their free time playing; Games are very static in that they have pre-defined decision paths that follow a pre-defined set of outcomes; In some video games, in-game avatars can adapt and change to player interactions over time (This avatar is contained and reflects changes within one game or one series of games. They generally vary on a one dimensional axis (either they look more evil or more good; either they look more healthy or more sickly). The style of these avatars fits within the context of the game); in current match making and community lobbies, players have separate avatars that are generally modeled after the real life appearance of the players (These avatars are created once and can be customized using pre-set characteristics. These avatars are used as a virtual representation of the player. Friends and acquaintances of the player use this avatar to visually identify the player).

The current limitation of avatar systems is that they are manually generated by the player and may not truly reflect or represent the player in real life. Action and decisions in games only affect the avatar's appearance specific to that game. The avatars (or the gamer's representation inside the game) are fixed and can only be manipulated at the start of the game. Games are static when it comes to the scenes that are shown in the background. They are pre-created and do not change. Games are limited to physical input—the user has to use their hands to cause an action to happen in the game (there are devices that now can use body gestures to control the game, but they are on static sites, and require hardware.

### SUMMARY OF THE INVENTION

Embodiments of the invention make use of psychology to build a psychological profile for each player. Data cultivated in our analytics system is piped through an analyzer in order to build user profiles. The use of this analyzer and the profiles it generates will then allow for the tailoring of unique and engaging gaming experiences on an individual level for all players involved across multiple products simultaneously.

According to a first aspect of the invention there is provided a game enhancement system for a video game or games played on a gaming platform wherein one or more players interact with the video game or games through an avatar representing their own persona within a virtual world, comprising a data gathering sub-system for gathering data relevant to the game or games in the real or virtual world; and a game server in communication with the gaming platform for dynamically modifying the game or games based on the gathered data.

The servers can be virtual or real running on one or many distributed platforms. The game enhancement system is particularly suitable for use in a cloud computing environment, wherein the game is offered as a “cloud service”. The system may modify an individual game or it can used the gathered data to modify a group of games based on the player's actions.

In one embodiment, the game server modifies the player's avatar to reflect his traits as determined by the gathered data. Captured data, such as a picture of the player, captured by a camera or otherwise retrieved, can be used to create a base avatar, which is then modified as more data is gathered during the course of the game. Data can also be derived from a player's gestures during the course of a game captured on camera.

In another aspect the invention provides a method of enhancing a video game or games played on a gaming platform wherein a player interacts with the video game or games through an avatar representing his own persona within a virtual world, comprising: gathering data relevant to the game or games in the real or virtual world; and dynamically modifying the game or games based on the gathered data.

The game may be modified in real time or near real time, which in this context means that the video game is modified as it is being played by the player in response to his or her actions through his or her corresponding avatar during the course of the game.

In yet another aspect the present invention provides a gaming module for installation on a gaming device used to play a game or games, wherein a player interacts with the video game or games through an avatar representing his own persona within a virtual world, comprising: a data collector for collecting data relevant to the player and sending the data to a gaming management system in real or near real time over a communications link; and a device game control module for dynamically modifying the game or games in real or near real time in response to commands received from the gaming management system.

In a still further aspect the invention provides a data analytics system for a video game wherein a player interacts with the video game through an avatar representing his own persona within a virtual environment, comprising: a data gathering module associated with the game for gathering data about the behavior of the avatar under the control of the player in response to virtual situations presented to the player within the game; an analytics module for analyzing the data collected by the data gathering module data to identify a player profile based on the gathered data relating to the behavior of the avatar under the control of the player; and a game modifying module modifies the virtual environment based on the identified profile of the player or a group of players.

### BRIEF DESCRIPTION OF THE DRAWINGS

The invention will now be described in more detail, by way of example only, with reference to the accompanying drawings, in which:

FIG. 1 is a high-level block diagram of a gaming system implementing an embodiment of the invention;

FIG. 2 depicts the server game software;

FIG. 3 is a detailed explanation of the software running on the Client Mobile Devices;

FIG. 4 is a representation of Game Play and what happens when a User hits a Node Option;

FIG. 5 gives details of the Device Game Control Software;

FIG. 6 illustrates psyche data mapping;

FIG. 7 illustrates real life achievement mapping;

FIG. 8 illustrates physical data mapping;

FIG. 9 illustrates trend data mapping;

FIG. 10 illustrates outcome data mapping;

FIG. 11 shows a possible way of presenting a user with potential players;

FIG. 12 is a chart showing how mappings can work for trait markers;

FIG. 13 depicts how ads and media are chosen to display in a particular Game;

FIG. 14 depicts how an Ad/Media/Current Event Data is stored in the Database;

FIG. 15 depicts the avatar software running on the server;

FIG. 16 depicts the process for updating an avatar;

FIG. 17 depicts the main lobby process;

FIG. 18 depicts the asset management software;

FIG. 19 depicts the production server software; and

FIG. 20 depicts the virtual world creation software.

### DETAILED DESCRIPTION

Embodiments of the invention employ social context gaming, which is a software-based method for collecting, aggregating, and analyzing detailed data regarding an individual's or group's social context, behavior, preferences, habits, and decisions during play of a digital video game. This data collection and reporting software will be integrated into the games downloadable software package. In addition to the data collection framework, each game title will also include software for a virtual lobby. Before entering into the game, players will be logged into the virtual lobby where they can see other avatars and view both social media and game related achievements, status updates, and information. Players will also be able to identify and interact with other game players and friends in real time. Each individual in the lobby will have his/her own avatar which is specific to the virtual lobby and dynamically based on the result of accumulated game play. This virtual avatar will reside on an external server.

Each game can be digitally distributed via a third party digital distribution channel.

Individuals who are interested in playing the game will download and install the game via the internet to their gaming device. Once installed, the game will act as gateway for the user to connect to and participate in the virtual lobby over an internet connection. Once inside the lobby, the player can then enter into the game. Additional game content, updates, upgrades, and subsequent episodes and editions will also be distributed via digital download, or in real time as the game is being played.

Resources available on mobile devices include: GPS, Accelerometer, Camera, Internet access, Data, Bluetooth (WiFi access), 3D to naked eye, Projector, Touchpad (how hard you are touching it), Fingerprint scanner (create a unique id/avatar/card based on fingerprint or gain access to virtual world places based on fingerprint), Track ball, Mouse, Face recognition, Translation (language), Holo-rendering, and 3D glasses that plug into the phone and uses the camera.

A sample of Web Services available to mobile devices includes: Google (maps, search, voice, docs, etc.), Email, Social sites (Facebook, LinkedIn, MySpace, etc.), Video analytics, Voice (Skype, Voxio), Storage and backup, Video conferencing, Amazon (CloudFront, Elastic Marketplace), Voice recognition, Text-to-speech, Speech-to-text, IVR, Augmented Reality, News Services, On-line newspapers, Radio, and Geotagging.

Embodiments of the invention take mobile gaming to a new level, where the game adapts itself depending on various inputs. Everything in the game from input, to characters, to the surrounding background, to the actual story line can be modified. Using all the different resources available, including fast cloud-based services, the game can morph itself and never be exactly the same for any given player.

Current game metrics tools allow the harvesting of specific data from players. Metrics such as time spent playing, location, time spent per screen, when players exiting the game, what the player is focused on, etc. are currently recorded with API's such as Flurry, Apsular, and Fuse. However, games strongly reflect the personality traits, fantasies and desires of the player. The metrics recorded in accordance with the present invention may include all player decisions within the context of the game, as well as video analytic data from images captured of the user while playing the game. Data captured will include everything from strategies the player employs, moral vs. immoral choices, weapons of preference, how weapons are used it, and which virtual characters they choose to interact with the most. Data for each player, across all the different games they play will be recorded and sent to a cloud server. A set of heuristics will be used to analyze and quantify this data on the cloud server. How players play games are a reflection on their own personality. This set of quantified values will provide a quantitative analysis of the player and provide an indicative view of their personality and traits. This detailed knowledge of the player coupled with traditional game metrics can be used in a variety of applications. The analysis of the player will be referred to as their Psyche Data. Data collected can be also be used to create Physical Data and Trend Data (what tendencies the player has when choosing things). Outcome Data can be derived by looking at data from a number of players and determining a percentage that take specific actions.

Collected data can be used to generate new episodic content. For example, if the majority of players save a princess in a game, the production staff for that game title can produce the next episode based on the majority consensus. If the majority of people choose not to save the princess, then the writers can produce the next episode with the princess slain.

Data collection can also affect the game in real time. As players make decisions, the game can be interacting with a cloud service that updates the game in real time with predetermined data, which may change certain paths or certain scenes that are shown or made available to the player. For example, if a player is tending to be more evil in nature, the background as he/she goes through the game can change to be darker, or if they are being good-natured, certain paths might be cut off because of it. If a player interacts with an object, the object may be changed based on the players psyche data, or be given different characteristics because of it. Geotagging and Augmented Reality can be used to reveal hidden objects and give games a local flavour.

As players play a game episode, stats can be shown about the choice that others (friends, the entire community of game players, etc.) made at this same point in the game. Social media will be integrated such that players can convince their friends to make a specific choice. For example if a players wants the princess to live and be available for inclusion in the next episode, then he/she would do their best to convince their friends to save her as well. Dashboard avatars can be used to represent the player outside of the games in the virtual worlds/lobby in between game sessions. This is where the player will interact with friends and others in the community. Traditionally avatars are generated manually by the user. Using scanning and camera technology a base avatar can be digitized for the user. With quantitative psyche data, the look of the player's base avatar can be dynamically transformed over time based on how the player plays games. These avatars would provide a true virtual representation of one's self as the avatar would be a manifestation the player's personality as quantified by how they play games.

Other game's avatars can be manipulated using this data, either by providing an API to update the avatar, or by a separate software wrapper which is individually targeted at specific games, and knows how to manipulate the games avatar, and does so using the psyche data to determine the choices.

The avatars can also “do their own thing” when left alone in the lobby, even when the player is not around. For example, avatars can leave graffiti, decorate with flowers, or move and hide objects in the lobby; all based on the players psyche data.

By understanding the personality of the user, target marketing can achieve even greater fidelity. Specific ads can be pushed to players based on the players' collected psyche data. For example, if a player always chooses to take a pickup truck as their getaway car in a game, the system could automatically push them ads for pickup trucks. Similarly, if the player is very generous and gives to virtual beggars in the market slums of a medieval village, the system could push them ads that appeal to sympathy. GPS will further help target advertisings. Media streaming can also be used to play radio stations, or video in game and media would be chosen based on a combination of GPS and psyche data.

The quantitative psyche data can be used to match the player with other similar players. As they play these games, the system will suggest individuals who are compatible friend matches for the player. GPS will be used to further refine suggested friends (e.g. suggest friends who are close and have similar personalities).

Current events can be used to modify the game or avatars to reflect what is going on in the real world. For example, the events of the 2010 revolution in Egypt, during which there were mass demonstrations, and a call to have the leader of Egypt resign, could have been incorporated very rapidly into a game in order to create a game based on current events. Real Time events can be used to change a ‘game shell’ to create quickly a relevant game that can change with the times.

Embodiments of the invention can be implemented as a cloud service that utilizes other cloud services like social sites, video analytics, voice services, translation services (text-to-speech etc.), storage and backup. It can also handle many devices connected to the WAN/LAN or 3/4G network (including smartphones and tablets) and automatically adapts to them based on their capabilities (see resource list).

Embodiments of the invention can implement dynamic storytelling based on social networking (changing situation in the game either in real time or in following episodes). Use AI to modify the game based on for example, the percentage of the community of players that save or destroy something. Or each player starts with a role in the game (e.g. a murder mystery), but the game/outcome changes based on how the players play it.

Advertisements may be built into game play—based on the actions that the person takes in the game (e.g. what car they select, or what food they eat), change the game. The insertion of ads can be dynamic so that the game can easily be updated based on which brand wants to ‘buy’ space. Trends can be reported to the advertisers. The ads chosen are based on the traits that the user has input into the game, for example if they choose to lift things in a game, then give them an ad for dumbbells, or if they are very sneaky in a game, give them an ad for night vision goggles.

Real-world happenings can be built into the games, such as latest news, weather, sports, store sales, movies. The game changes dynamically based on this external input.

Players can be automatically updated on what is happening out in the real world without having to listen to the news or read a newspaper, based on where they are currently located. For example, if a gamer gets into the car, then the local radio they chose can be piped in, or if they go to a movie theater, the latest movies playing can be on the billboard. Again, the media chosen are based on the traits that the user has input into the game, for example, if they tend to evil, pick a local ad for an appropriate movie for that trait (e.g. Friday the 13^{th} vs. Superman).

The game itself may be in the form of a shell, and all the characters, advertising and objects are created and downloaded based on current events, so that the game is always fresh.

The game employs a digital representation of a player generated using Psyche Data. The process of generating an avatar based on personality traits, tendencies and behavioural patterns may be applied in combination with manual input and input scanners (biometrics, imaging, etc.). This data reflects the player's personality and actions over time. This system is intended to provide a true and accurate reflection of the player's nature. This virtual representation is unique and one-to-one to the player. Once constructed, these unique avatars can be dropped arbitrarily into virtual worlds, games, community lobbies and social media sites.

The player's picture can be captured and turned into an avatar, and as the player plays the game, the visual aspect of their avatar is dynamically changed to reflect the emotion/disposition and physical characteristics of the play to them and other players (e.g. more evil or more good or happier or sadder, lift a lot of weights—get more muscles, etc.). The game may have a pre-game virtual lobby, where the avatar is created, and gamers congregate before entering into various pre-existing games from different companies. The avatar created is used in all the games, and takes on traits based on all the different games played.

Hand or face gestures and body position/posture can be used as input to the psyche data—e.g. a smile means one thing, a frown means another, jumping up and down means excitement, etc.

Geotagging and Augmented Reality can be used to reveal hidden objects in games, that can change based on whether or not a previous player (social networking) has done something to it. Devices such fingerprint scanning/recognition or biometrics can be employed to create an encrypted and unique identifier to create a new character/object in the game, or to allow access to restricted areas.

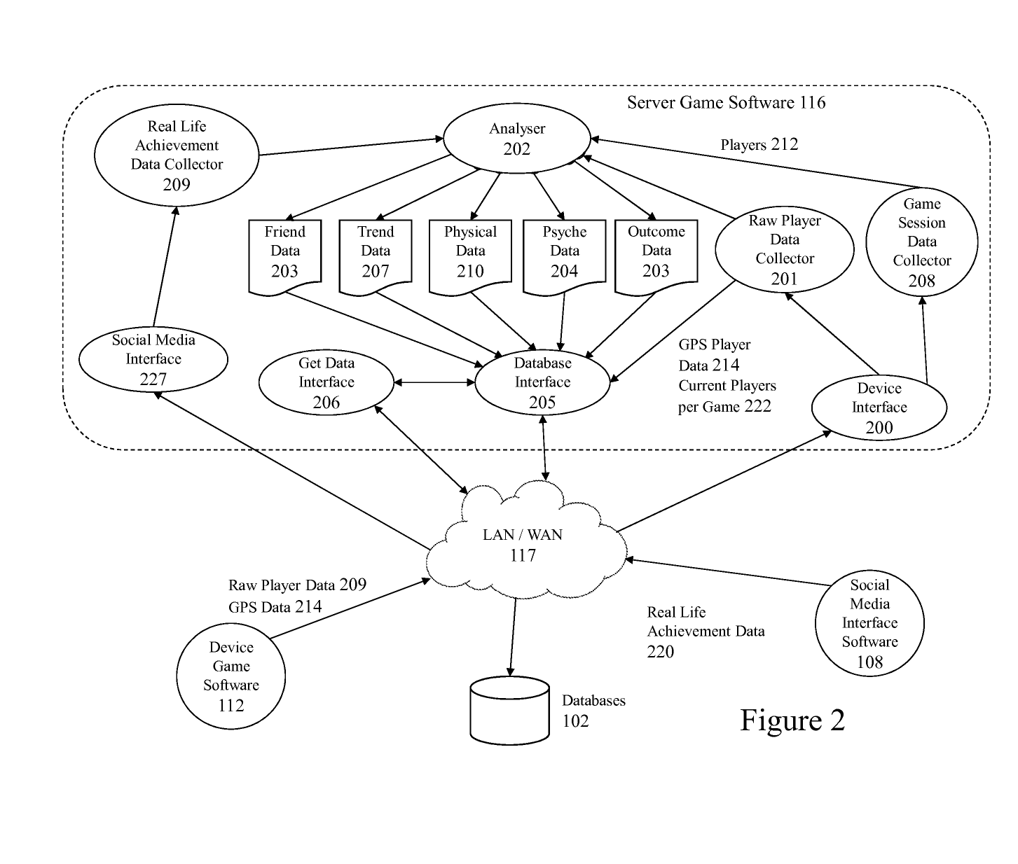

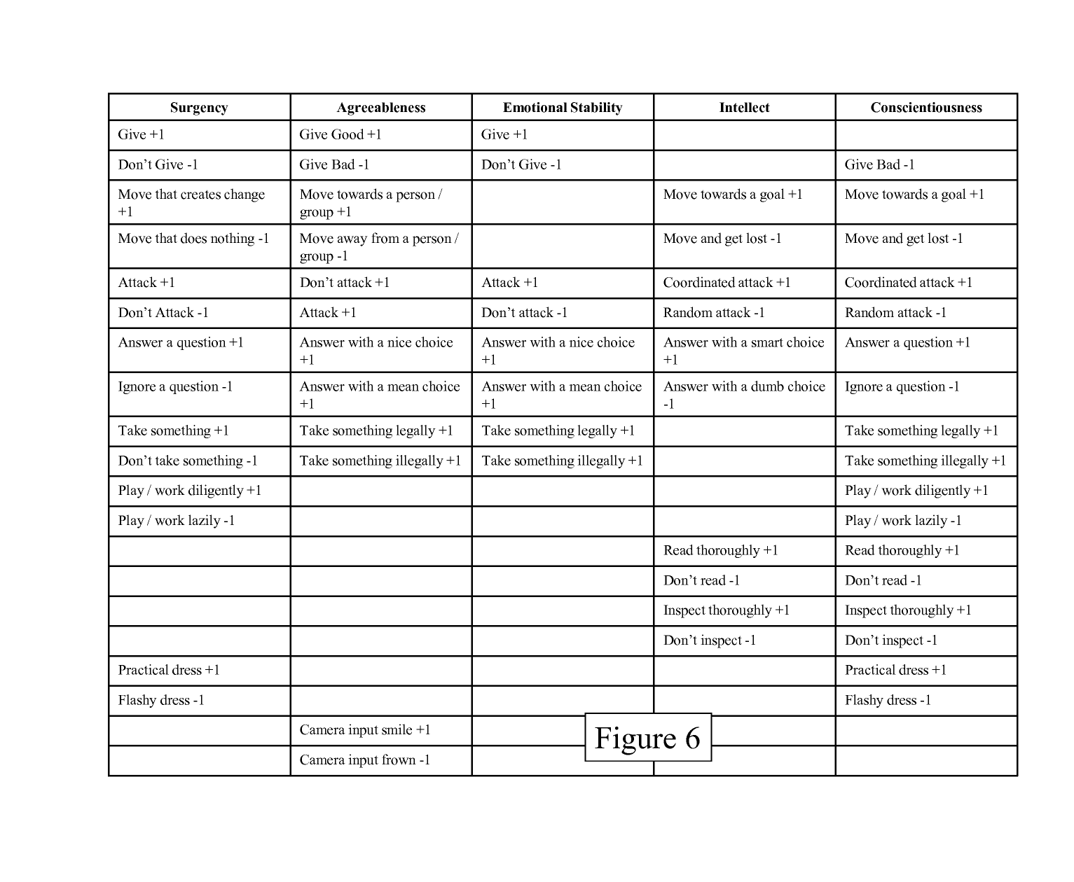

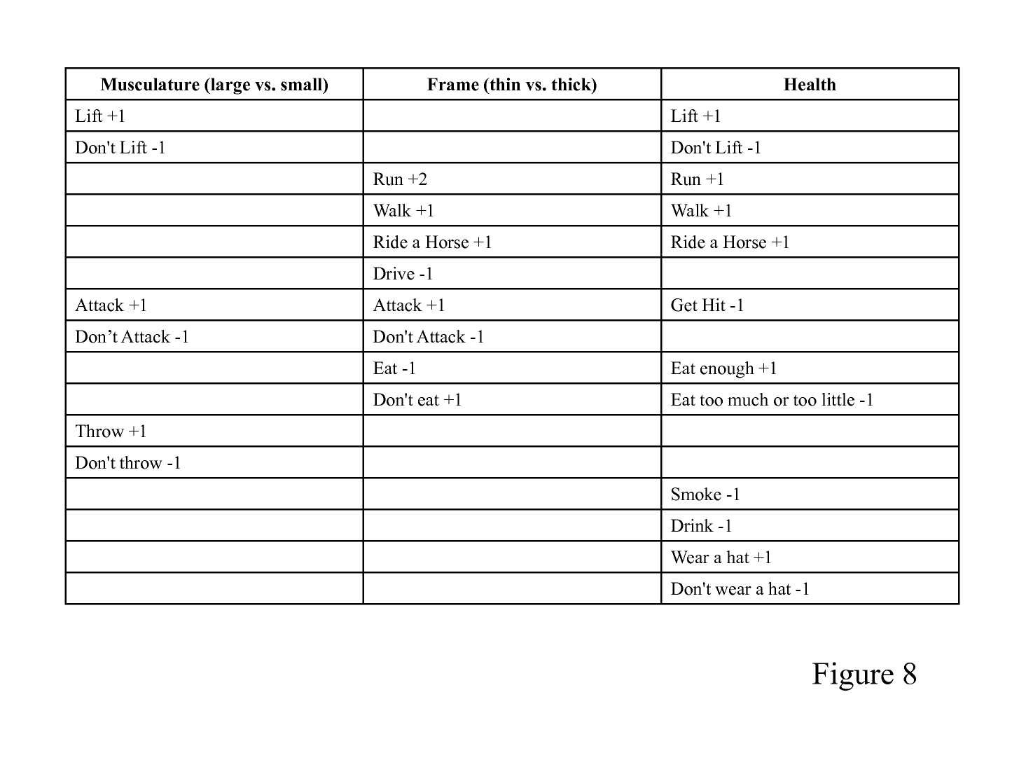

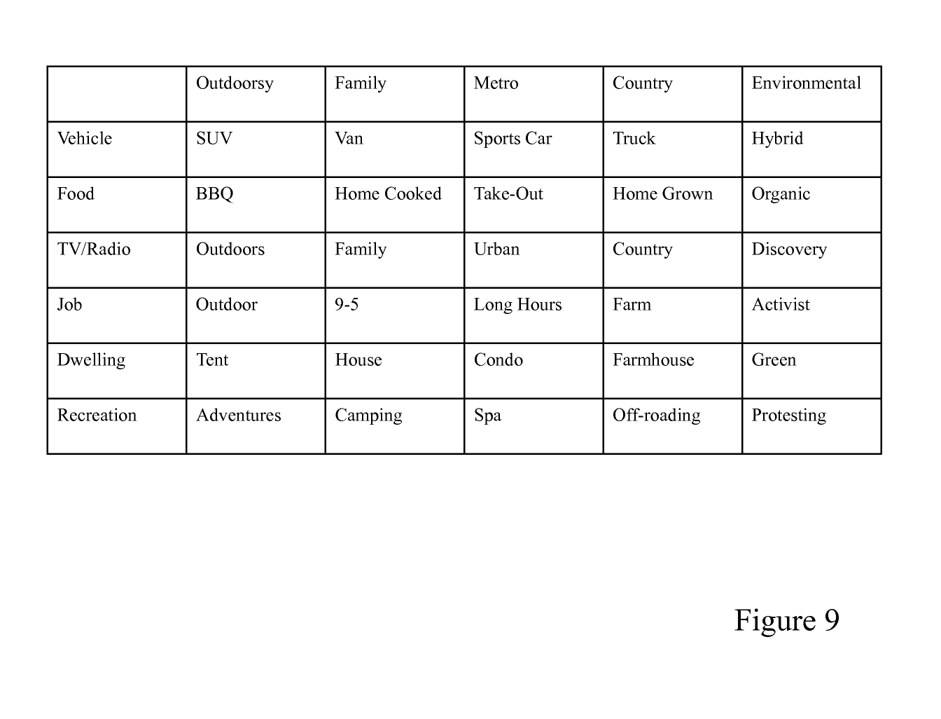

An important aspect of the invention is the mapping of actions taken in the game to the five main trait markers, three physical markers and five Trend Markers in order to create Psyche Data, Physical Data and Trend Data. This can be done in many ways, but an example of how it can be done for Psyche Data is: the game is broken down into 10 actions: Give, Attack, Move, Answer, Take, Play/Work, Read, Inspect, Dress, External Input (from a camera, face and body). These are characterized as positive and negative actions, which affect the score of a particular trait. FIG. 6 is a chart of how these mappings could work for trait markers. As this data is collected, the scores in each of the 5 traits are normalized into a number from negative 2 to positive 2. This gives a scale to be used when creating avatars, choosing friends or modifying branches in a game. FIG. 8 shows a similar mapping that can be done for physical data. FIG. 9 shows a similar mapping for trend data. These can be used by the Analyzer 202 shown in FIG. 2.

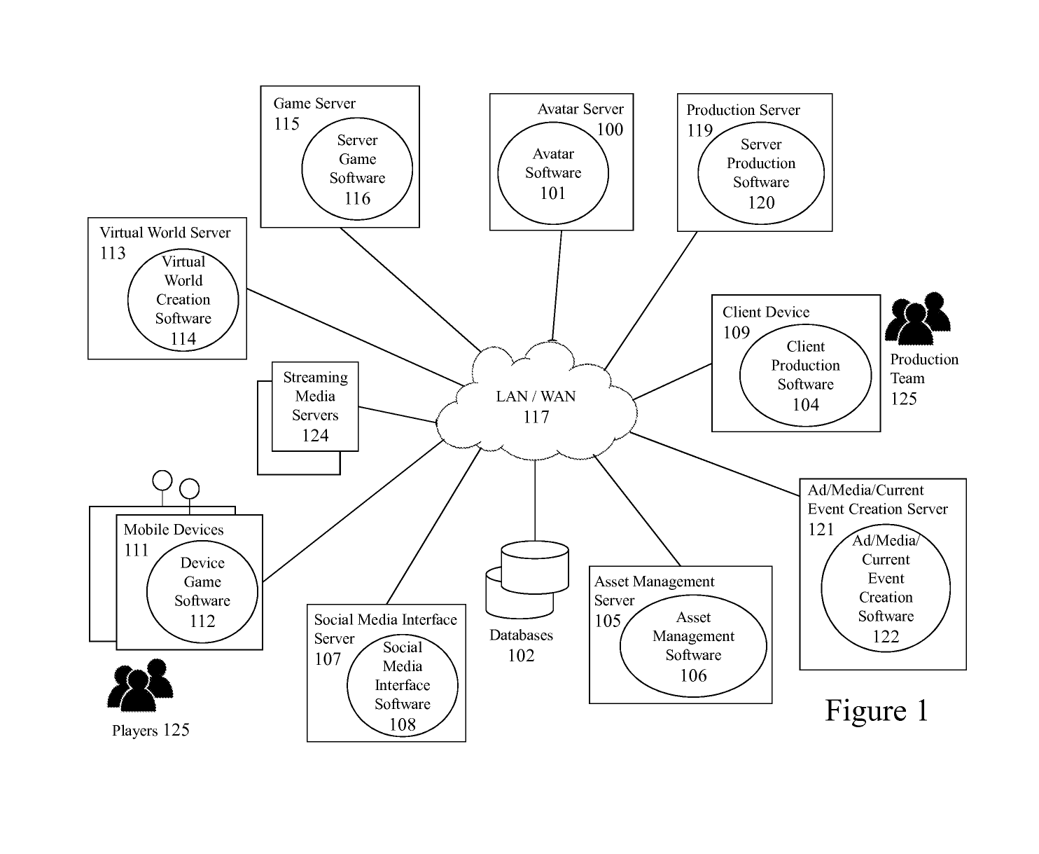

A gaming system in accordance with an embodiment of the invention is shown in FIG. 1, where a number of virtual servers, which can reside on the same hardware or different hardware, are connected to the LAN/WAN 117.

The Avatar Server 100 runs the Avatar Software 101, which is responsible for creating and maintaining game avatars. It also holds the Avatar Lobby and manages the interactions with all the players in a Lobby, including recommending friends to play with.

The Production Server 119, runs the Server Production Software 120 which connects via the LAN/WAN 117 to Client Production Software 104 running on a Client Device 109. This software is responsible for the creation of new games, or parts of games by the Production Team 103. Once new assets are created they are given to the Asset Management Software 106 running on the Asset Management Server 105.

The Ad/Media Creation Server 121 runs the Ad/Media Creation Software 122. This software is responsible for storing and choosing the correct ads and media to be shown/played in a game or lobby. The Streaming Media Servers 124 contain content for streaming to the game being played on the Client Device 109.

The Asset Management Software 106 that runs on the Asset Management Server 105 is responsible for storing and offering for sale the games, episodes, etc. It is also responsible for streaming any new content in real time to the Device Game Software 112.

The Social Media Server 107 running the Social Media Software 108 pushes and receives data to and from social media sites/networks in relation to a game, including suggestions on moves to make, and real life achievements that can affect Psyche, Physical and Trend data.

Mobile Devices 111 run Device Game Software 112, which handles the playing of the game for the user, and interacts with all the other servers to send and receive new information.

Virtual World Server 113 runs the Virtual World Creation Software 114, which takes input from a social media site, and creates a Virtual World for a user based on the data it receives from the Social Media Software 108.

Databases 102 connected to the WAN/LAN 117 store information for the various applications running on the servers.

FIG. 2 shows the Server Game Software 116 running on the Game Server 115 in more detail. The Device Game Software 112 collects data as the player plays the game. The Social Media Interface Software 108 also collects real life achievement data about the user. All this data is sent to the Server Game Software 116 via the LAN/WAN 117 to the Device Interface software 200 and the Social Media Interface 221. The Raw Player Data Collector software 201 collects the mobile device data (including GPS Data 214 and data on what players are currently playing a particular game 222, which it stores in the Database 102 using the Database Interface 205) and sorts it by player and gives it to the Analyzer 202. The Game Session Data Collector 208 collects all the players playing or about to play a particular game. The Real Life Achievement Data Collector 209 collects this data and sorts it by player and gives it to the Analyzer 202. This has plug-ins which can use all the different data collected and split it up into categories:

Outcome Data 203, which is data collected from multiple users that affects a single game's subsequent outcomes;

Psyche Data 204, which is data on a User's trait markers;

Physical Data 210 which affects a User's physical characteristics;

Trend Data 207, which affects a single player over many games; and

Friend Data 213, which uses different User's data to recommend players for a particular game. FIGS. 6, 7, 8, 9 and 10 give an example of the way the data could be mapped. This is stored into a Database 102 using a Database Interface 205. Other software also needs to get data for a game or a player, and it does this through the Get Data Interface 206, which can get Outcome Data 203 or Friend Data 213 for a game, or Psyche Data 204, Physical Data 210 and Trend Data 207 for a particular player. It uses the Database Interface 205 to do this.

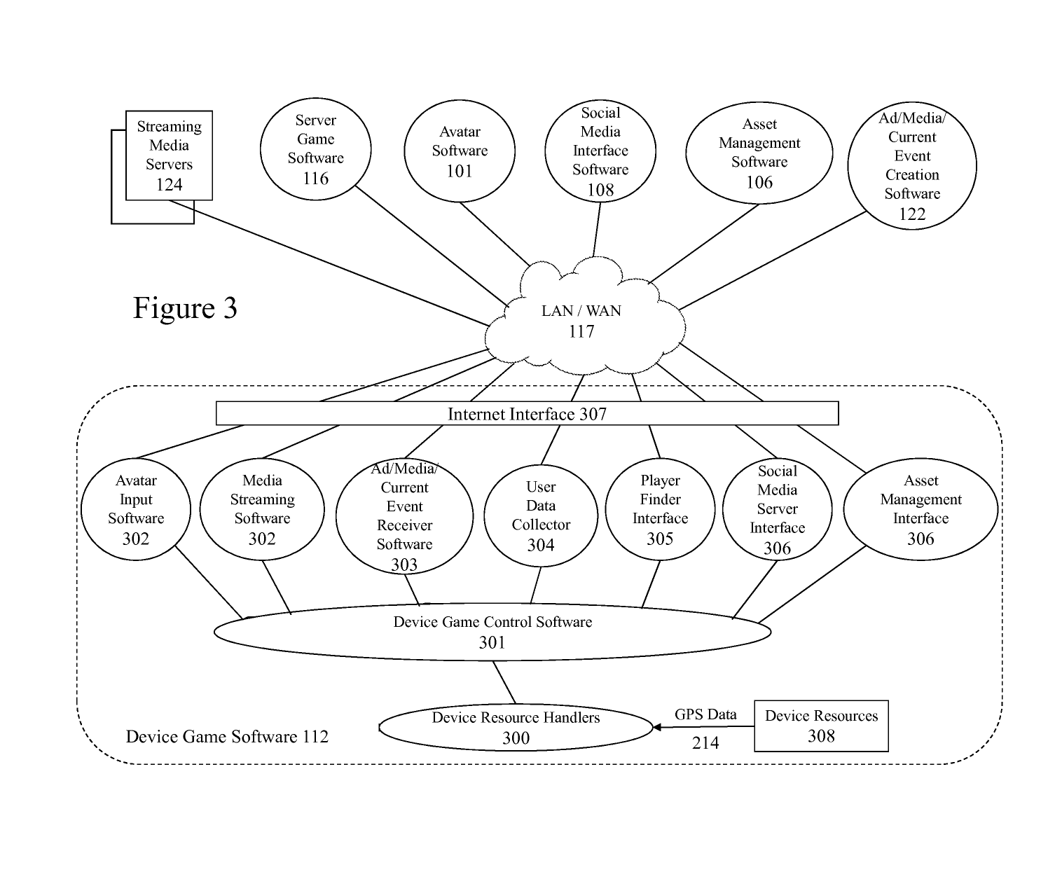

FIG. 3 illustrates in more detail the software running on the Mobile Devices 111. The Device Game Software 112 interfaces with all the Device Resources 308 like the camera, the GPS system (retrieving GPS Data 214), the accelerometer, etc. through specific Device Resource Input Handlers 300. This data is input into the Device Game Control Software 301, which handles the game play. The Device Game Control Software 301 also analyzes this data, and sends the relevant data to the Server Game Software 116 through the User Data Collector 304, which formats the data and sends it on. Other data that is input into the Device Game Control Software 301 comes from external sources via the LAN/WAN 117 through the device Internet Interface 307. These external sources include the Avatar Software 101, the Social Media Interface Software 108, the Asset Management Software 106 the Ad/Media/Current Event Creation Software 122, the Server Game Software 116, the Streaming Media Servers 124 and from the Social Media Interface Software 108, which interacts with, for example, Facebook and Twitter. The receipt of this data is handled through the Avatar Input Software 302, The Ad/Media/Current Event Receiver Software 303, the Asset Management Interface Software 310, the Media Streaming Software 311 and the Social Media Server Interface software 306 and the Player Finder Interface 305.

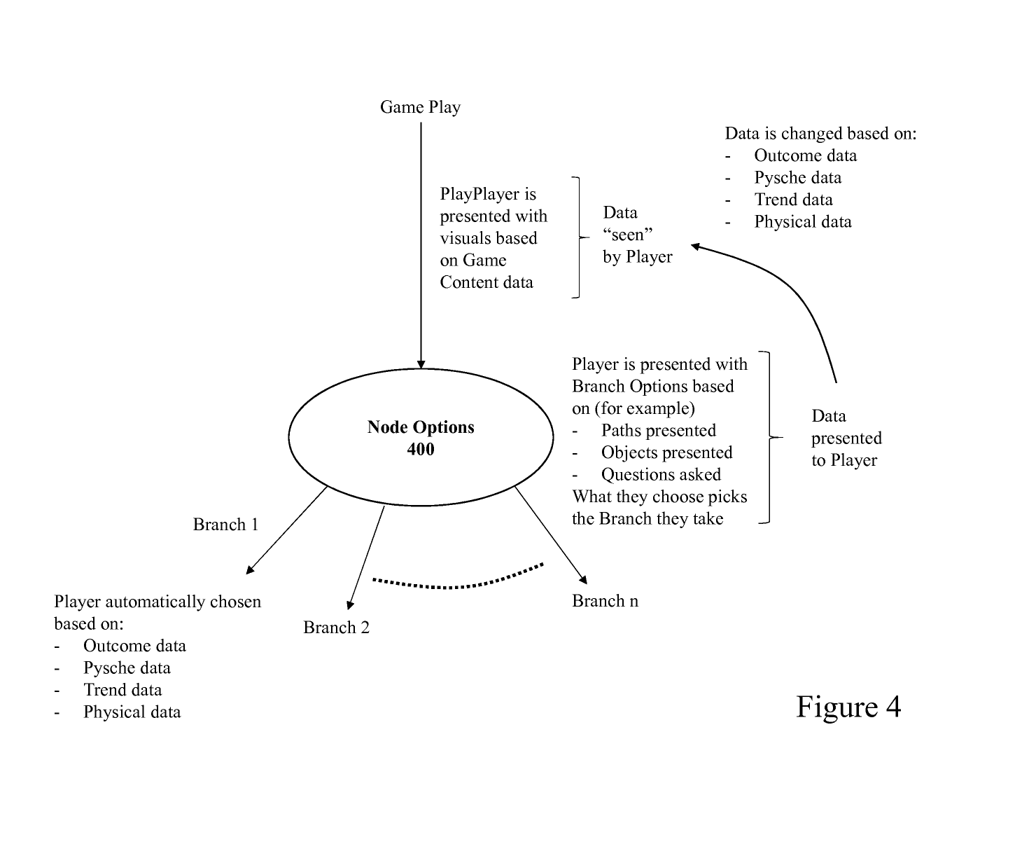

FIG. 4 is a representation of Game Play and what happens when a user hits a Node Option 400 in the game. At this point the player is presented with visuals based on game content data. The options can include: paths presented; objects presented; and questions asked.

When this happens, the data presented to the player (objects, questions or paths) can change based on Psyche Data 204, Physical Data 210, Trend Data 207 or Outcome Data 203.

Alternately a Branch in a Node Option can be chosen automatically because of this data.

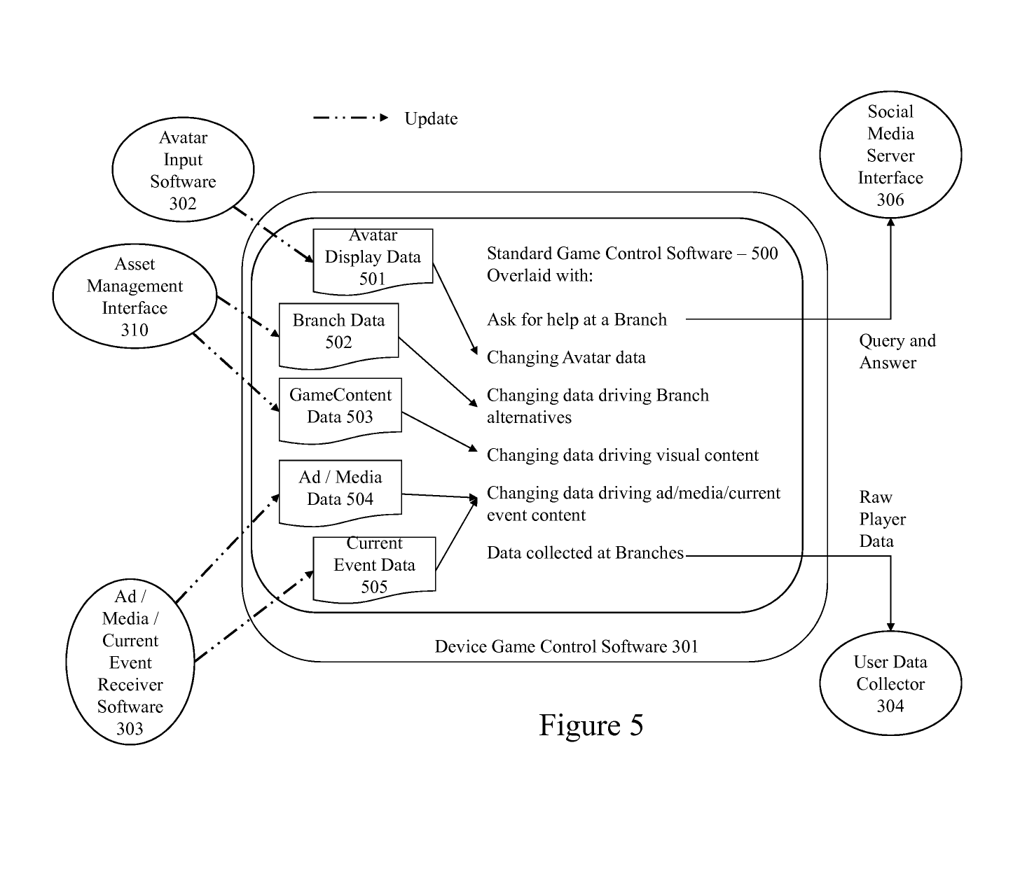

FIG. 5 shows more detail on the Device Game Control Software 301. It uses Standard Game Control Software 500 overlaid with software, which could: ask for help when a particular Node is reached (when this happens the software interfaces with the Social Media Server Interface 306 to ask and receive comments, which are displayed to the user through the Device Resource Handlers 300 and game play resumes when the user selects a path in the Branch 400); display the custom Avatar using the Avatar Display Data 501 for the player which it receives from the Avatar Input Software 302; change branch options, or game content by receiving Branch Data 502 and Game Content Data 503 from the Asset Management Interface 310; offer different Ad/Media Data 504 or Current Event Data 505 received from the Ad/Media Current Event Receiver Software 303; and send data collected at Nodes to the Server Game Software 116 through the User Data Collector 304

FIGS. 6, 7, 8, 9 and 10 show possible examples of how Analyzer 202 output is achieved. These tables can all be hard coded and set up ahead of time, and then a simple lookup would be done when the action comes in.

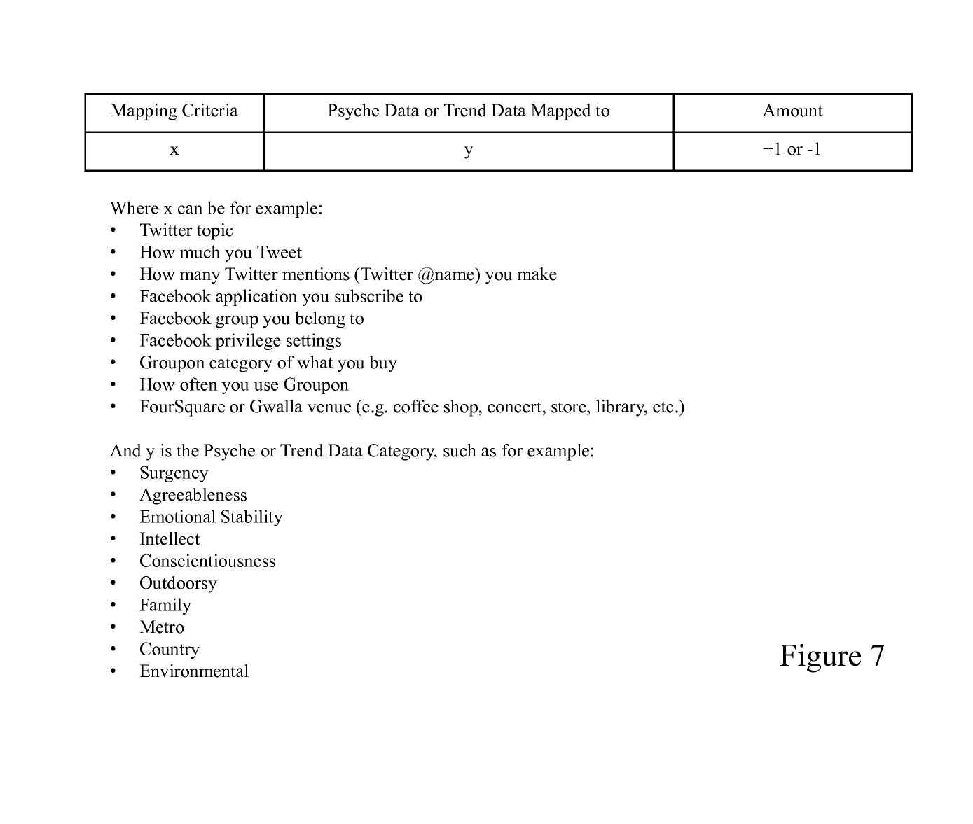

FIG. 6 is an example of the possible mapping of actions into Psyche Data 204 for a user. FIG. 7 is an example of the possible mapping of real life achievements into Psyche Data 204 or Trend Data 207 for a user.

FIG. 8 is an example of the possible mapping of actions into Physical Data 210 for a User.

FIG. 9 is an example of the possible mapping of choices made in the game into Trend Data 207 for a User.

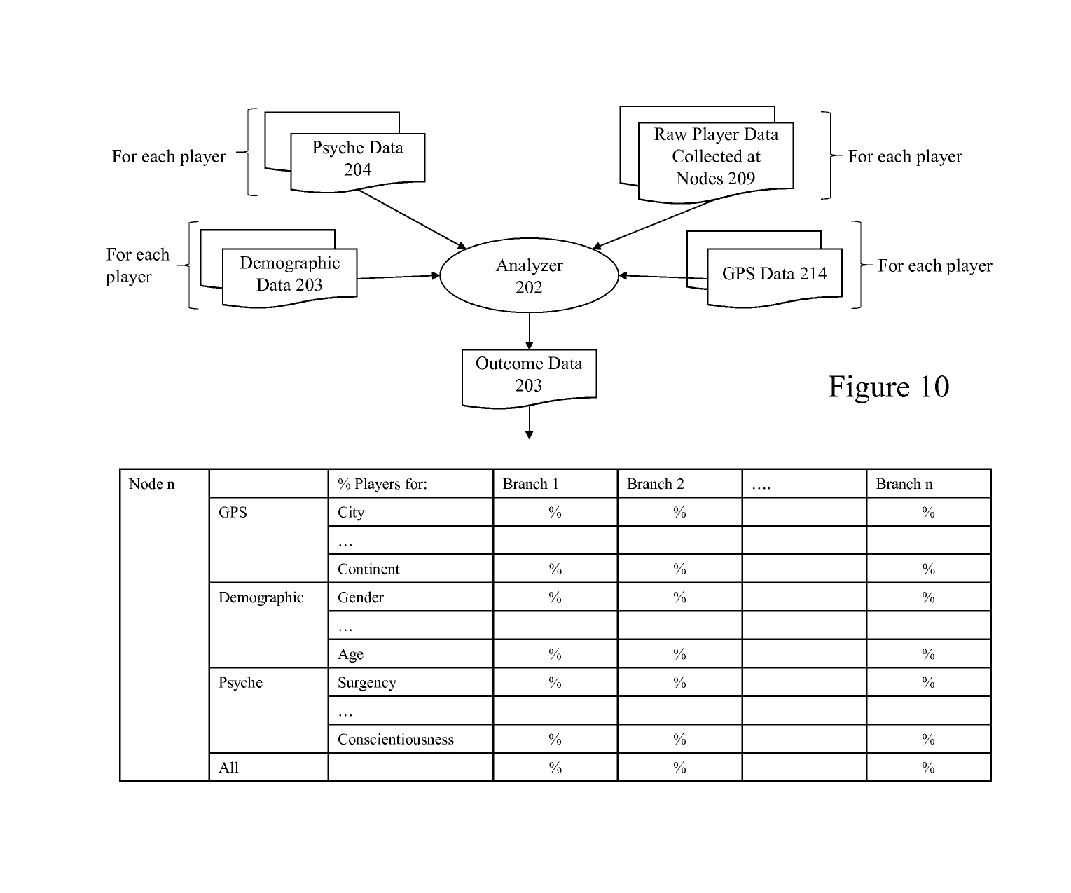

FIG. 10 is an example of the possible mapping of data for a particular game into Outcome Data 203. Demographic Data 1000 is collected when a user buys a game. GPS Data 214 comes from the Raw Player Data Collector 201. The Raw Player Data 209 collected at a particular Node over many players is received from the Raw Player Data Collector 201 and stored in the Database 102. For a particular Node “n” in a game, it maps the percentage of players that made a particular Branch choice, broken into sub-categories according to: where they are (GPS), further broken down into for example City, Country, Continent; their particular demographic, for example gender, age; The five Psyche Data categories; and a combination of all choices irrespective of the above.

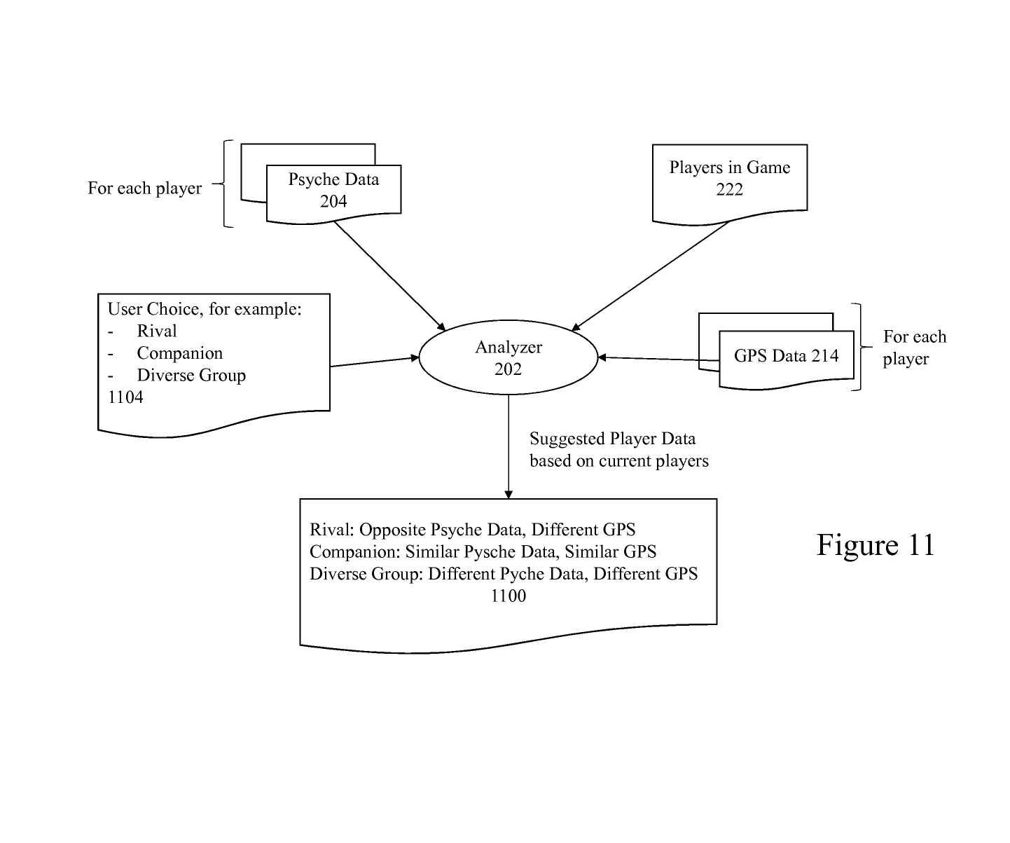

FIG. 11 shows a possible way of presenting a user with potential players to play the game with. The Analyzer 202 takes data on all players in the game or about to start the game 222, GPS Data 214 for those players, the Psyche Data 204 for those players and the type of person the user wants to play with 1 104 (for example, Rival, Companion, Diverse Group) and then makes a suggestion as to what players to pick. For example 1 100, if a Rival is wanted it could look for a player with opposite psyche data and a different GPS. If a companion is wanted it could pick a player with similar psyche data and a similar GPS. If they want to have a Diverse group, then it could pick a number (determined by user) of players with different GPS and all different Psyche Data 204.

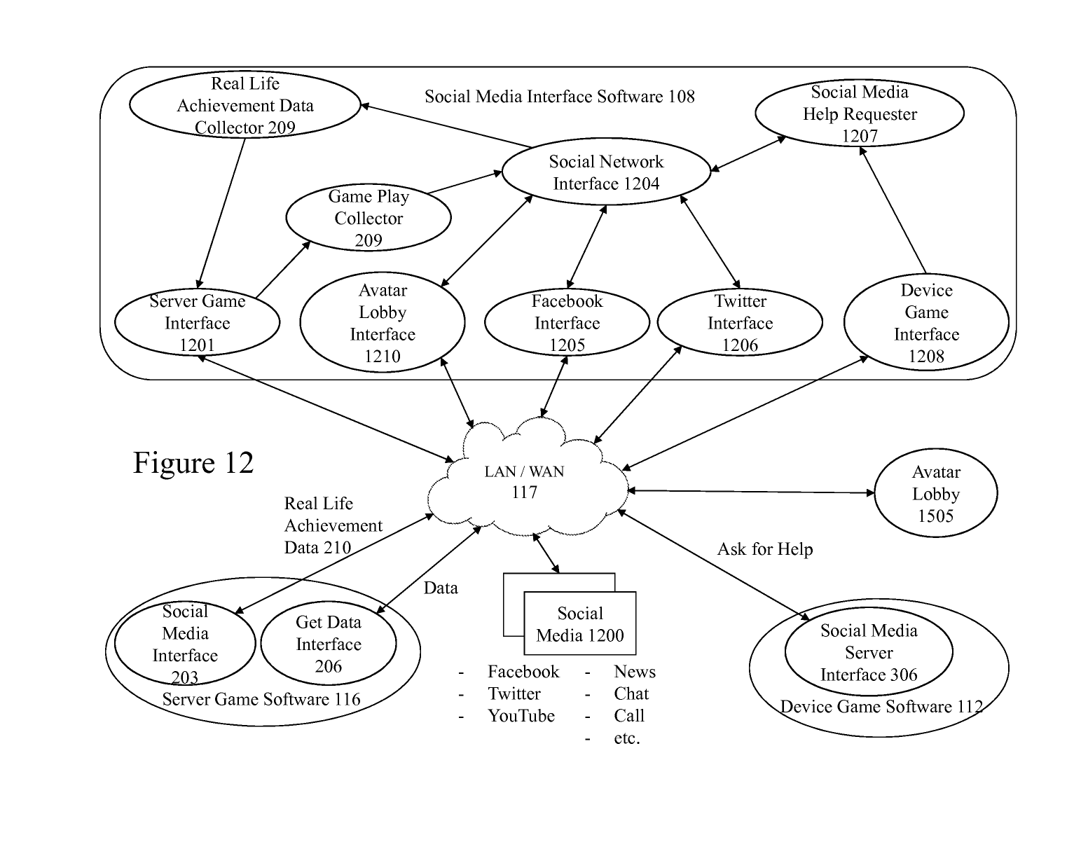

FIG. 12 is a detailed explanation of the Social Media Interface Software 108 running on the Social Media Interface Server 107. It interfaces with the Server Game Software 1 16 through a Server Game Interface 1201. The Game Play Collector 1209 gets the data from the Database 102, formats it, and passes it to the Social Network Interface software 1204. The different Social Interfaces 1204 (for example a Facebook Interface 1205, or a Twitter Interface 1206) post details on how the user is playing the game using Social Media 1200. A player can ask for opinions from social media friends, through the Social Media Server Interface 306, which is received through the Device Game Interface 1208. The Social Media Help Requestor 1207 takes a request from a player for help from the social media contacts, uses the Social Network Interface 1204 to post the questions and receive the answers on Social Media 1200, and give the player a synopsis of the answers through the Device Game Interface 1208. Real life achievements posted on Social Media 1200 can be received via the Social Network Interfaces 1204, and given to the Real Life Achievement Data Collector software 209, which will pass these to the Social Media Interface 221 through the Server Game Interface 1201. While in a Lobby 1505, a User can ask to interact with other players in the lobby. It asks for these sessions to be set up using the Avatar Lobby Interface 1210, which uses the Social Network Interface 1204 to set up the appropriate session with the Social Media 1200.

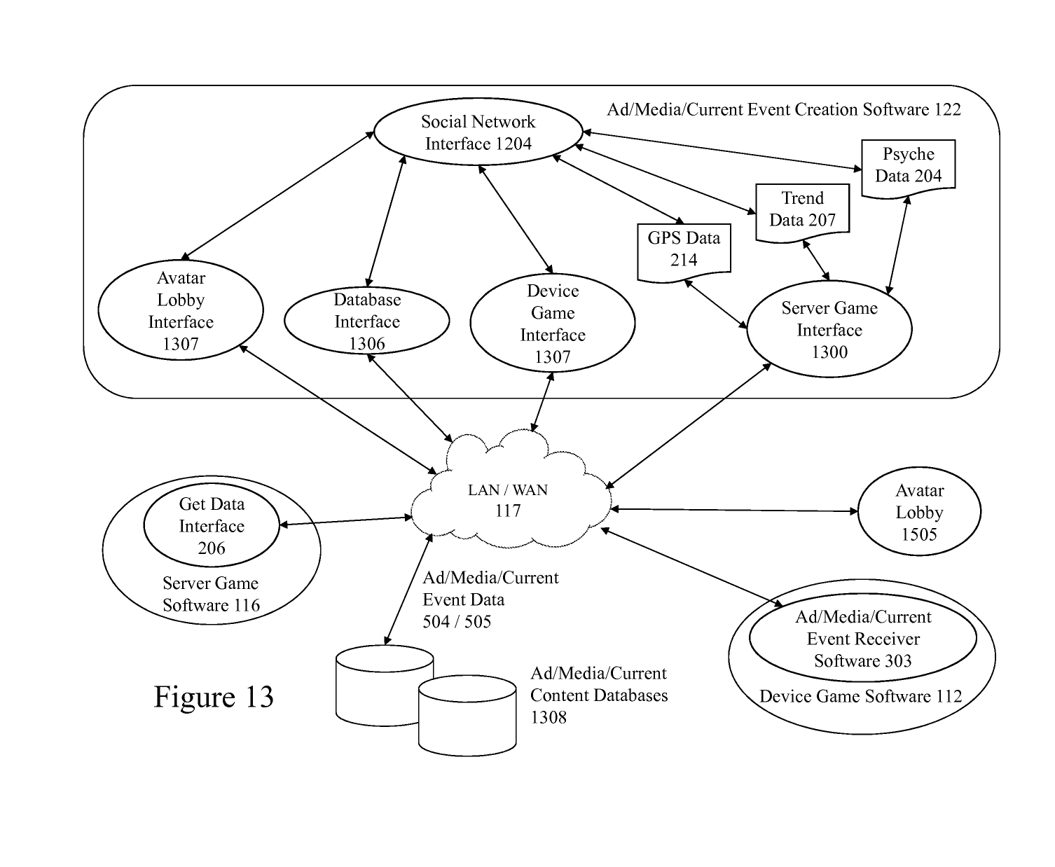

FIG. 13 explains how ads, media and current events are chosen to display in a particular game or lobby for a particular player. The Server Game Interface software 1300 gets the Psyche Data 204, GPS Data 214 and Trend Data 207 for a user from the Get Data Interface 206. The Analyze Data and Choose Ads/Media/Content software 1305 uses this data to determine what ads to display in the game or lobby and what media to stream (for example a radio station, or music or current events) or what content to display based on this data. It then passes these choices to the Ad/Media/Current Event Receiver Software 303 through the Device Game Interface 1307, or the Avatar Lobby 1505 through the Avatar Lobby Interface 1308. The Ad/Media/Current Event data 504, 505 are retrieved from the Ad/Media/Current Event Content Database 1309 using Database Interface 1306. They are stored based on Trend Data 207 and Psyche Data 204.

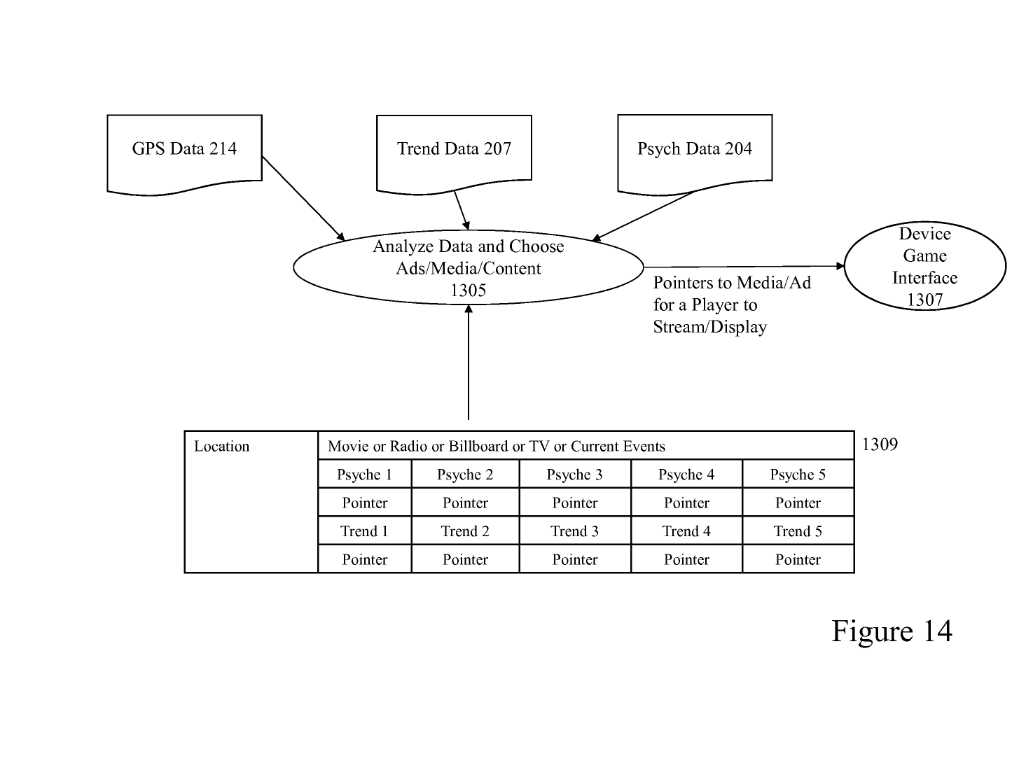

FIG. 14 shows how the Ad/Media/Current Event Data 504, 505 is stored in the database for subsequent retrieval using the Trend 207, GPS 214 and Psyche 204 data. For a particular location “n” (where the user is located), pointers to the different media/content data (movie, radio, billboard, TV, current events) are stored based on the 5 Psyche Traits, or the 5 Trends. Depending on where the user is in the game, different requests can be made. The pointers are used to find the data to stream in the Streaming Media Servers 124.

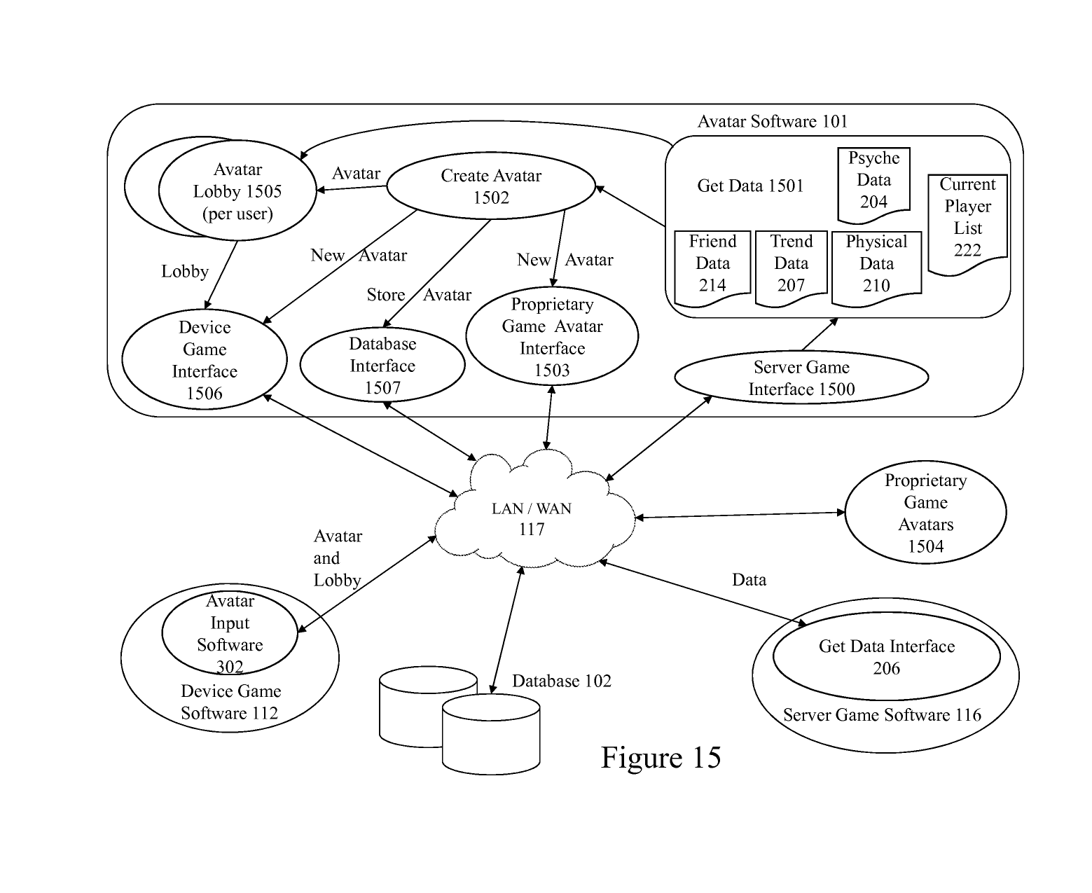

In FIG. 15, the Avatar Server Software 101 running on the Avatar Server 100 is responsible for creating and morphing a player's avatar based on how they are playing their various games. This is done by using the Psyche Data 204, the Physical Data 210 and the Trend Data 207 collected for the user. At program med intervals, for each player, the Get Data software 1501 gets the player's Data from the Server Game Software 1 16 through the Server Game Interface 1500. The Create Avatar software 1502 then uses this data to create an avatar for the player, or to change the avatar based on the data. This is stored in the Databases 102 through a Database Interface 1507. Once the avatar is updated, it is posted in the Avatar Lobby 1505, and it is sent to the Device Game Software 1 12 through the Device Game Interface software 1506. As well, if the user has avatars in a proprietary game 1504, then these avatars can also be updated by using the Proprietary Game Avatar Interface 1503.

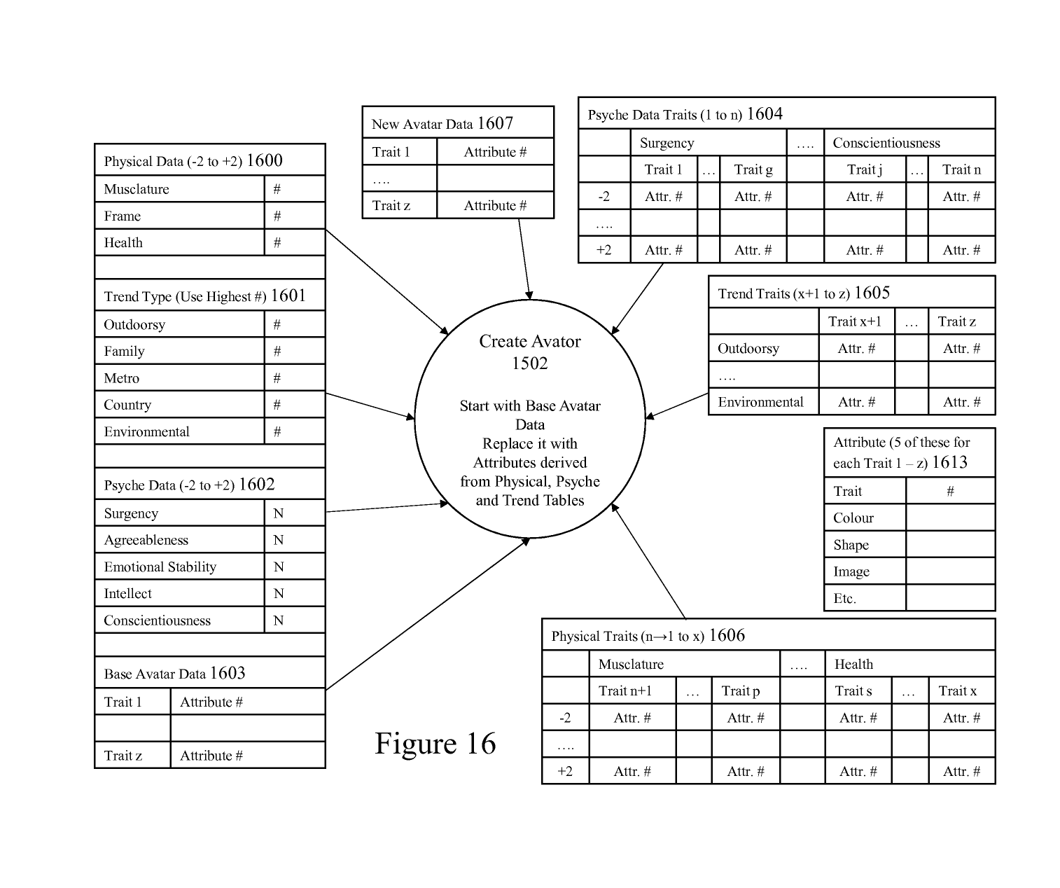

FIG. 16 explains a possible method of how the Create Avatar software 1502 uses the data given with data stored to create a new avatar. An Avatar is just data broken down into constituent parts of the Avatar called Traits, for example: ears, eyes, hair, nose, arms, legs, skin colour, weapons, headgear, clothing, etc. Each Trait has a number of instances called Attributes 1613. An Attribute describes the particular Trait. There are 5 Attributes for each Trait. For a particular user, the Analyzer 202 (see FIG. 2), determines a normalized number N (from −2 to +2) for each type within each of the Physical and Psyche Data 1600, 1602, and a Trend Type T 1601, which is chosen based on the highest number within the Trend numbers. There are pre-defined Tables 1604 and 1606, which have an attribute number for each subset of Traits for each number N for Psyche Data 204, and Physical Data 210. There is also a pre-defined Table 1605, which has an attribute number for each subset of Traits for each Trend Type T 1601. Initially Create Avatar software 1502 starts with Base Avatar Data 1603, which defines a default Attribute Number for each Trait. The Create Avatar software 1502, then takes each number N and the Trend Type T 1601 to rebuild the Avatar by replacing each trait with the new corresponding attribute number to create new avatar Data 1 607. The Tables 1604, 1605, and 1606 are filled in so that there is no overlap between traits.

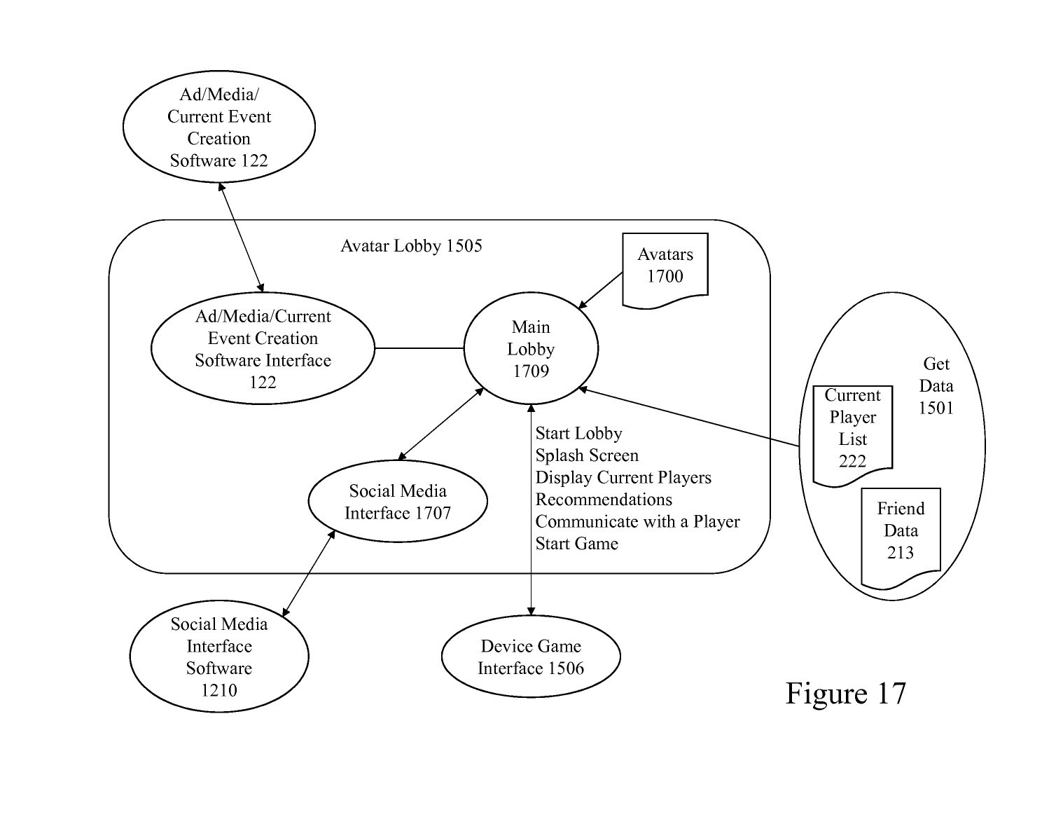

FIG. 17 is a detailed description of the Avatar Lobby 1505. The Main Lobby software 1709 uses the Get Data software 1501 to get the current Player List 222 and to Friend Data 213 based on the user and what they are looking for. The Main Lobby software 1709 uses the Device Game Interface 1506 to interface with the Device Game Software 112 to start the lobby display, display current players, display the current user avatar, recommend players to play the game with, to select players to play the game with, and to request a communication session between players. It interacts with the Social Media Software 1210 through the Social Media Interface 1707 to set communications up. The Main Lobby software 1709 also interfaces with the Ad/Media/Current Event Creation Software 122, through the Ad/Media/Current Event Creation Software Interface 1706 to get appropriate ads and media and content to display/stream in the lobby. This is then sent to the Device Game Software 112 through the Device Game Interface 1506.

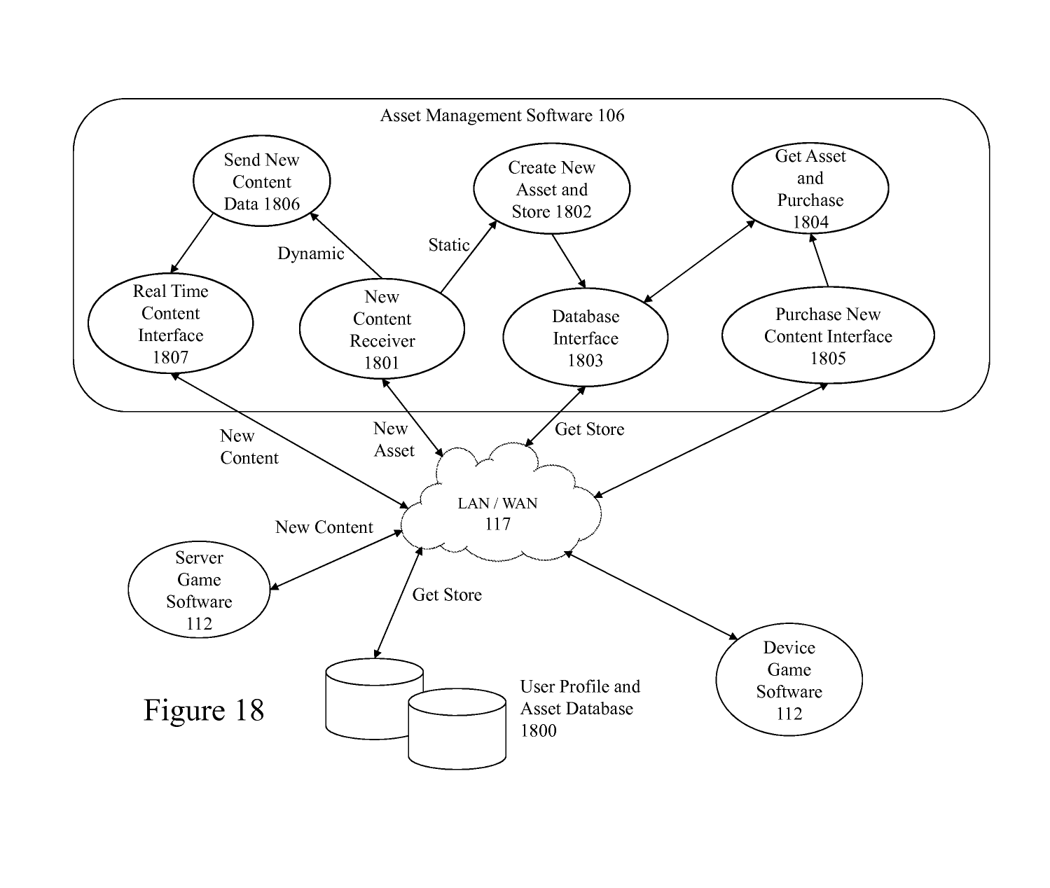

Referring to FIG. 18, the Asset Management Software 106 runs on the Asset Management Server 105. As new/updated content is received through the New Content Receiver 1801 from the Production Server Software 120, it splits it into the two types. If it is a new episode or game which is available for purchase, then it passes it to the Create New Content Asset and Store software 1802, which uses the Database Interface 1803 to store it in the User Profile and Asset Database 1800. If a user wishes to buy new content, then the Device Game Software 1 12 running on the client device interfaces to the Get Asset and Purchase software 1804 through the Purchase New Content Interface 1805, which then retrieves the content from the Asset Database 1800 and provides the means for the client to purchase and download it. If the New Content Receiver 1801 receives content that needs to update an existing game, then the Send New Content Data software 1806 sends it to the Device Game Software 112 through the Real Time Content Interface 1807.

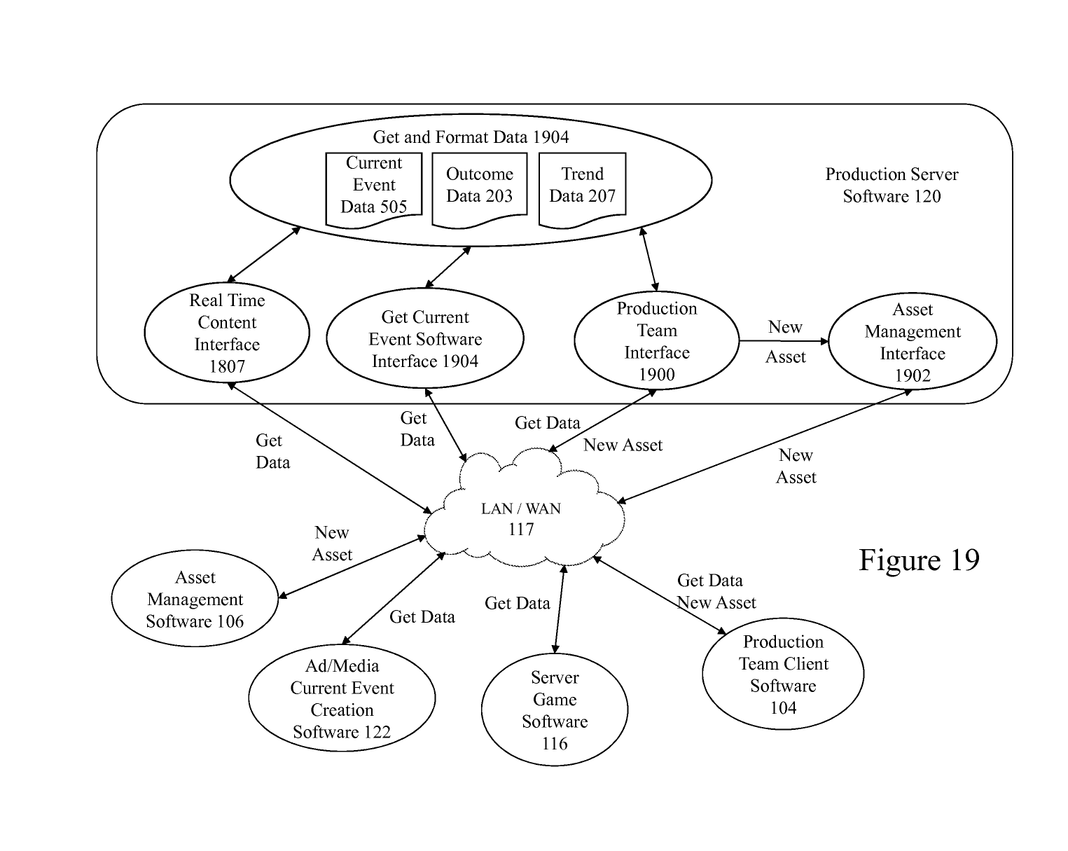

In FIG. 19, the Production Server Software 120 running on the Production Server 1 19 is responsible for providing an interface to the Production Team Members 103 to let them create, update and manage the game software. Production Team Members 103 use Production Team Client Software 104 to interface to the Production Server Software's 120 Production Team Interface 1900. From there they can get the Outcome Data 203 and Trend Data 207 from the Get and Format Data software 1905. These are retrieved from the Server Game Software 1 16 through the Server Game Interface 1903. They can also get Current Event Data 505 that is accessed through the Get Current Event Software Interface 1904. Once they have created new software, or updated a current game's software, then it is sent to the Asset Management Software 106 through the Asset Management Interface 1902.

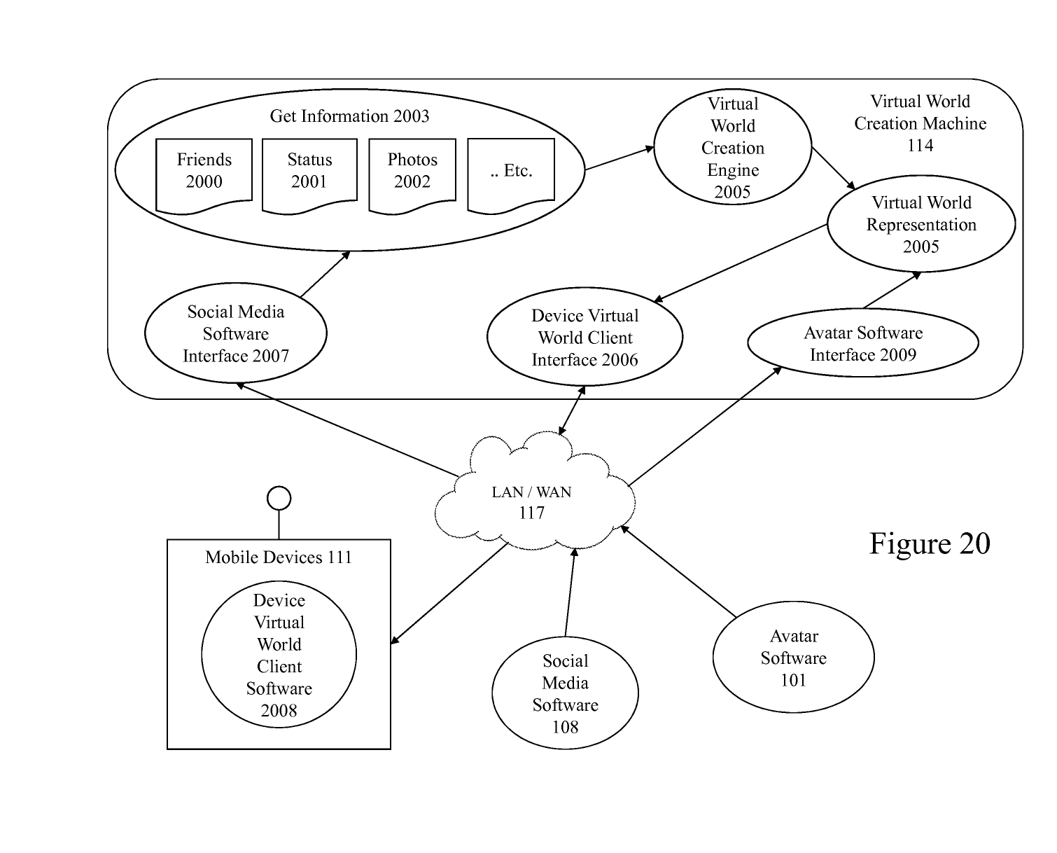

FIG. 20 shows how a virtual world representation can be done based on data received from social media for a particular user. The Social Media Software Interface 2007 interfaces to the Social Media Software 108. From there it gets Information 2003 (for example Friends 2000, Status, 2001, Photos 2002, etc.) which are fed into the Virtual World Creation Engine 2004. This engine creates a virtual world for the user based on all these inputs. This is passed to the Virtual World Representation software 2005, which can get avatars for friends that have them from the Avatar Software 101 using the Avatar Software Interface 2009. Once the virtual world is represented, a client on a Mobile Device 111 can view it through Device Virtual World Client Software 2008, which interfaces with the Device Virtual World Client Interface software 2006.

It should be appreciated by those skilled in the art that any block diagrams herein represent conceptual views of illustrative circuitry embodying the principles of the invention. For example, a processor may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” should not be construed to refer exclusively to hardware capable of executing software, and may implicitly include, without limitation, digital signal processor (DSP) hardware, network processor, application specific integrated circuit (ASIC), field programmable gate array (FPGA), read only memory (ROM) for storing software, random access memory (RAM), and non-volatile storage. Other hardware, conventional and/or custom, may also be included.

What is claimed is:

1. A game enhancement system for a video game or games played on a gaming platform wherein one or more players interact with the video game or games through an avatar representing their own persona within a virtual world, comprising:
a data gathering sub-system for gathering data relevant to the game or games in the real or virtual world; and
a game server in communication with the gaming platform for dynamically modifying the game or games based on the gathered data.

2. A game enhancement system accordingly to claim 1, wherein
the gathered data comprises at least one of:
trait data characteristic of a particular player's traits derived from his avatar's actions; and
trait data comprising data selected from at least one of psyche data, physical data, and trend data.

3. A game enhancement system according to claim 1 wherein,
the game server determines a particular player's psyche in response to gestures captured by the data gathering sub-system relating to the particular player at least one of directly from a controller for the gaming platform employed by the particular player or from a gesture determination module receiving visual data relating to the particular player during their game playing.

4. A game enhancement system according to claim 1, wherein
the game server is configured to at least one:
modify the avatar of the player or players to reflect their traits determined from the gathered data; and
to initially create a base avatar based upon data relating to characteristics of the player and subsequently modify the base avatar to reflect the player's traits determined from the gathered data; and
the gathered data comprises at least one of:
trait data characteristic of a particular player's traits derived from his avatar's actions; and
trait data comprising data selected from at least one of psyche data, physical data, and trend data.

5. A game enhancement system according to claim 1, wherein
an analyzer comprising part of the game server is configured to create a player profile in dependence upon at least mapping the player's actions during the course of the game against predetermined trait markers indicative of the player's personality using at least one of a predetermined scoring system and a scoring system responsive to the player's actions during the game.

6. A game enhancement system according to claim 5, wherein
at least one of:
the player's actions are categorized by specific positive and negative actions that are assigned scores affecting a particular trait marker; and
the scores for each trait marker are normalized into a common scoring system.

7. A game enhancement system according to claim 1, wherein
an analyzer comprising part of the game server analyzes the gathered data to create data sets forming predetermined portions of the player's profile, the gathered data relating to data selected from at least one psyche data, physical data, trend data, friend data, and outcome data, wherein
the friend data recommends players for a particular game; and
outcome data is data collected from multiple players whose actions affect a particular game's subsequent outcomes.

8. A game enhancement system according to claim 1, wherein
an analyzer comprising part of the game server analyzes the gathered data to create data sets forming predetermined portions of the player's profile, the gathered data relating to data selected from at least one psyche data, physical data, trend data, friend data, and outcome data, wherein
the game server is configured to modify aspects of the game relating to at least one of avatars, friend recommendations, and game branches.

9. A game enhancement system according to claim 1, further comprising;
a social media server for gathering data from social media feeds associated with at least a predetermined player of the one or more players; and
a virtual world server for modifying a virtual world within the game or games based on the data gathered from the social media feeds.

10. A game enhancement system according to claim 1, wherein
the game server is configured to collect position information pertaining to the location of at least a predetermined subset of the one or more players and modify an aspect of the game or games presented to the one or more players based upon the collected position information, the aspect being other than weather related and an environment associated with the predetermined subset of the one or more players.

11. The game enhancement system according to claim 1, further comprising;
a game production server which generates in dependence upon at least the gathered data at least one of a new game, a new episode within a game, a variant of an existing episode within a game, content for a game, and a new option for presentation to a predetermined subset of the one or more player.

12. The game enhancement system according to claim 1, wherein
the game server is configured to modify a game based upon analysis of the collective responses of players through their avatars to situations presented within the game, another game, or a group of games.

13. The game enhancement system according to claim 1, further comprising;
an avatar server for creating avatars based on the gathered data for each particular player and maintaining an avatar lobby containing avatars associated with players allowing a player to at least one of interact with other players of a game or games, establish a group of players to play a game or games, and select avatars for playing a game or games.

14. A method of enhancing a video game or games played on a gaming platform wherein a player interacts with the video game or games through an avatar representing his own persona within a virtual world, comprising:
gathering data relevant to the game or games in the real or virtual world; and
dynamically modifying the game or games based on the gathered data.

15. The method according to claim 14, wherein
the gathered data relates to the actions of a particular player through their avatar in response to situations presented to the player within the game or games and is used to create a player profile characteristic of the personality of the player.

16. The method according to claim 14, wherein
the player profile contains at least one of data descriptive of the player's personality, psyche data of the player, and trend data for the player.

17. The method according to claim 14, wherein
the data gathered comprises psyche data which is processed to establish at least one characteristic trait markers of a plurality of trait markers within the psyche data and these trait markers are mapped against the player's actions within the game using a scoring system based on positive and negative actions to obtain normalized scores for each trait marker.

18. The method according to claim 14, wherein
the data is collected from a number of different players and used to determine the outcome of a game or games.

19. The method according to claim 14, further comprising
creating an avatar lobby containing avatars having characteristics based on the gathered data and allowing a player to at least one of interact with other players of a game or games, establish a group of players to play a game or games, and select avatars for playing a game or games.

20. The method according to claim 14, wherein
the gathered data comprises real world data generated from social media feeds associated with the player which forms at least one of part of the player's profile and configuration data used to modify a virtual environment within the game or games.

21. The method according to claim 14, wherein
the gathered data is used to create or modify at least one of a new game, a new episode within a game, a variant of an existing episode within a game, content for a game, and a new option for presentation to a predetermined subset of the one or more player.

22. The method according to claim 14, wherein
the gathered data is used to modify a group of games whereby the player's actions within one game have an effect across more than one game.

23. A gaming module for installation on a gaming device used to play a game or games, wherein a player interacts with the video game or games through an avatar representing his own persona within a virtual world, comprising:
a data collector for collecting data relevant to the player and sending the data to a gaming management system in real or near real time over a communications link; and
a device game control module for dynamically modifying the game or games in real or near real time in response to commands received from the gaming management system.

24. The gaming module according to claim 23, wherein
the data collector at least one of:
collects data pertaining to the player's actions within the game or games for analysis in the gaming management system;
collects data obtained from social media feeds relevant to the player; and
transmits data collected within the game to a social media feed relating to the player.

25. The gaming module according to claim 23, wherein
the device game control module is configured to modify the game based on the player's personality profile as determined by the gaming management system from the gathered data.

26. A data analytics system for a video game or games wherein a player interacts with the video game through an avatar representing his own persona within a virtual environment, comprising:
a data gathering module associated with the game or games for gathering data about the behavior of the avatar under the control of the player in response to virtual situations presented to the player within the game or games;
an analytics module for analyzing the data collected by the data gathering module data to identify a player profile based on the gathered data relating to the behavior of the avatar under the control of the player; and
a game modifying module modifies the virtual environment based on the identified profile of the player or a group of players.

27. The data analytics system as claimed in claim 26, wherein
the gaming environment is modified to reflect the interests or characteristics of the player.

28. The data analytics system as claimed in claim 26, wherein
the data analytics module is configured to at least one of:
create a player profile by mapping trait markers to the player's actions within the game; and
assign normalized scores to actions within the game to particular trait markers to create a normalized player profile.

29. The data analytics system as claimed in claim 26, wherein
targeted advertisements are integrated into the game environment based on the player's profile.
